(19) United States
(12) Patent Application Publication
(10) Pub. No.: US 2025/0012696 A1
(43) Pub. Date: Jan. 9, 2025

(54) Method and System for Detecting One or More Probe Microparticles

(71) Applicant: Rutgers, The State University of New Jersey, New Brunswick, NJ (US)

(72) Inventors: Umer Hassan, Monmouth Junction, NJ (US); Brandon Ashley, Carteret, NJ (US); Mehdi Javanmard, Princeton Junction, NJ (US)

(21) Appl. No.: 18/761,686

(22) Filed: Jul. 2, 2024

Related U.S. Application Data
(60) Provisional application No. 63/511,784, filed on Jul. 3, 2023.

(51) Int. Cl. G01N 15/01; G01N 15/1409; G01N 15/1429

(52) U.S. Cl. CPC G01N 15/01; G01N 15/1409; G01N 15/1431

(57) ABSTRACT

Embodiments include methods, systems, and computer program products for detecting probe microparticle(s). One such embodiment applies an electric field to a biological entity. The electric field includes multiple frequencies. One or more of the multiple frequencies correspond to respective types of probe microparticles. Each type of probe microparticle includes a core and at least a partial metal oxide coating. Further, each type of probe microparticle is configured to produce a response corresponding to a respective frequency and conjugate to a corresponding type of biological entity. Responsive to applying the electric field, a response signal is measured. Then, based on the measured response signal, a presence or absence of probe microparticle(s) conjugated to the biological entity is detected.

### RELATED APPLICATION

This application claims the benefit of U.S. Provisional Application No. 63/511,784, filed on Jul. 3, 2023. The entire teachings of the above application are incorporated herein by reference.

### GOVERNMENT SUPPORT

This invention was made with government support under Grant No. 827291 and Award No. 2002511 from the National Science Foundation (NSF), and Training Grant No. T32 GM135141 from the National Institute of General Medical Sciences (NIGMS) as part of the National Institutes of Health (NIH). The government has certain rights in the invention.

### BACKGROUND

The growing need for personalized, accurate, and non-invasive diagnostic technology has resulted in significant advancements in medical technologies, including innovative developments related to various disease-related biomarkers. Generally, flow cytometry is a specialized technology whereby cells, biomarkers, and particles are quantified. Impedance cytometry can be used to detect cells, proteins, and nucleic acids.

### SUMMARY

Most in vitro diagnostics are designed for single biomarker detection. A point-of-care (POC) device for detecting multiple biomarkers simultaneously (e.g., by employing a multiplexing capability) is needed for accurate diagnosis and prognosis of complicated disease.

Certain embodiments of the present disclosure relate to systems and methods for detecting frequency-specific barcoded and antibody-conjugated microparticles using multifrequency impedance cytometry and machine learning. The microparticles are semi-coated with different thickness of metal oxides, according to an embodiment. Cells express surface antigens that can be recognized and captured by antibodies conjugated to the microparticles, according to an embodiment. Cell and cell-microparticle complexes can be differentiated from one another using multi-frequency impedance measurements and machine learning, according to an embodiment.

Other embodiments relate to a multifrequency microfluidic impedance cytometer for detecting and counting specific cell types based on surface antigens and a method for quantifying the expression level of surface antigens (e.g., detecting activation of certain cells) using antibody-conjugated microparticles semi-coated with different thickness of metal oxide, e.g., Al₂O₃. Further, yet other embodiments relate to microparticles semi-coated with different thickness of Al₂O₃ that produce unique signals at different voltages frequencies and that can serve as barcodes for detecting different small analytes bound to the microparticles. It is unexpected that the impedance signature of the cell-microparticle complex is dominated by the microparticles, given that microparticles are much smaller than the cells.

According to an embodiment, potential products, commercial applications, and applicable markets or industries may include one or more of a biosensor for detecting specific cell types based on a surface receptor or antigen and a POC device for disease diagnosis and/or prognosis.

Existing approaches may include flow cytometry where cells expressing specific antigens can be detected and counted, including the expression level of the antigen, by use of fluorophore-conjugated antibodies.

Some embodiments offer advantages including much reduced costs as compared to a flow cytometry instrument, portability, and/or ease of operation, among other examples.

Certain embodiments deliver improvements over existing approaches including by teaching the use of use antibody-conjugated microparticles and machine learning to differentiate biological entities, e.g., cells. Other embodiments provide advancements such as by, instead of magnetic beads, employing metal oxide coated microparticles for biological entity binding with multiplexing capabilities.

One such example embodiment is directed to a method for detecting probe microparticle(s). The method includes applying an electric field to a biological entity. The electric field includes multiple frequencies. One or more of the multiple frequencies correspond to respective types of probe microparticles. Each type of probe microparticle includes a core and at least a partial metal oxide coating. Further, each type of probe microparticle is configured to produce a response corresponding to a respective frequency and conjugate to a corresponding type of biological entity. Responsive to applying the electric field, the method then measures a response signal. Based on the measured response signal, a presence or absence of probe microparticle(s) conjugated to the biological entity is detected.

In an embodiment, the method may further include, responsive to detecting the presence of the probe microparticle(s), determining a property or properties of the biological entity. According to another embodiment, the method may further include classifying the biological entity based on the property or properties.

In an embodiment, the biological entity may be a cell.

According to an embodiment, the method may further include demodulating the measured response signal into multiple signals corresponding to the multiple frequencies.

In an embodiment, the biological entity may be flowed through a detector in a conductive medium, and the detector may be used to apply the electric field and measure the response signal. According to another embodiment, the detector may be a multifrequency impedance cytometer, and the measured response signal may be an impedance response.

According to an embodiment, for a given type of probe microparticle, the type of probe microparticle may be configured to conjugate to the corresponding type of biological entity by binding to surface receptor(s) associated with the corresponding type of biological entity. In another embodiment, the surface receptor(s) may include antigen(s) and the type of probe microparticle may be functionalized with an antibody or antibodies configured to bind the antigen(s).

In an embodiment, for a given type of probe microparticle, the metal oxide may be an aluminum oxide, a hafnium oxide, or a titanium oxide.

According to an embodiment, for a given type of probe microparticle, the metal oxide coating may have a thickness in a range of about 5 nm-30 nm.

In an embodiment, each of the one or more of the multiple frequencies corresponding to respective types of probe microparticles may be in a range of about 1 MHz-30 MHz and another of the multiple frequencies may be a reference frequency in a range of about 100 kHz-1 MHz.

In an embodiment, each of the one or more of the multiple frequencies may be selected based on a property or properties of the respective type of probe microparticle. According to another embodiment, the property or properties may include metal oxide material and/or coating thickness.

In an embodiment, a machine learning model may be used to detect the presence or absence of the probe microparticle(s). According to another embodiment, the machine learning model may include a neural network model, a support vector machine model, a naïve Bayes model, and/or an ensemble classifier model. In yet another embodiment, the machine learning model may be configured to analyze feature(s) associated with the measured response signal. The feature(s) may include at least bipolar amplitude.

Another example embodiment is directed to a system for detecting probe microparticle(s). The system includes a detector, a processor, and a memory with computer code instructions stored thereon. In such an embodiment, the processor and the memory, with the computer code instructions, are configured to cause the system to implement any embodiments or combination of embodiments described herein.

Yet another example embodiment is directed to a non-transitory computer program product for detecting probe microparticle(s). The computer program product includes a computer-readable medium with computer code instructions stored thereon. In such an embodiment, the computer code instructions are configured, when executed by a processor, to cause an apparatus associated with the processor to implement any embodiments or combination of embodiments described herein.

It is noted that embodiments of the method, system, and computer program product may be configured to implement any embodiments, or combination of embodiments, described herein.

### BRIEF DESCRIPTION OF THE DRAWINGS

The patent or application file contains at least one drawing executed in color. Copies of this patent or patent application publication with color drawings will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIGS. 1A-1E are a graphical overview of electrically-sensitive biological entity receptor detection according to an embodiment.

FIGS. 2A-2D depict an overview of multifrequency impedance cytometry and video microscopy instrumentation and data collection according to an embodiment.

FIG. 3 is a block diagram of a system for machine learning according to an embodiment.

FIGS. 4A-4C illustrate relative bipolar amplitude scatter dot plots according to an embodiment.

FIG. 4D depicts a histogram plot of exemplary percentage change of average bipolar amplitude according to an embodiment.

FIGS. 5A-5C depict histogram plots of exemplary average reported accuracy differentiating different classified groups according to an embodiment.

FIGS. 6A and 6B depict comparison information for a first individual sample according to an embodiment.

FIGS. 7A and 7B depict comparison information for a second individual sample according to an embodiment.

FIGS. 8A and 8B depict comparison information for a third individual sample according to an embodiment.

FIGS. 9A-9C depict histogram plots of reported accuracy differentiating different classified groups, according to an embodiment.

FIG. 9D depicts graphs of receiver operating characteristic (ROC) curves of pooled data for the comparisons of FIGS. 9A-9C, according to an embodiment.

FIG. 10 depicts an overview of a multifrequency impedance cytometry device and probe microparticle detection scheme, according to an embodiment.

FIGS. 11A-11F depict brightfield and false-colored fluorescence imaging of metal oxide Janus particles (MOJPs), according to an embodiment.

FIGS. 12A-12C are scatter plots of bipolar amplitude data collected from multifrequency impedance cytometry, according to an embodiment.

FIG. 13 depicts bar plots comparing line of best fit slopes from impedance cytometry pulse data across different frequencies, according to an embodiment.

FIGS. 14A-14C are graphs of ROC curves classifying all multifrequency impedance cytometry pulse data, according to an embodiment.

FIGS. 15A-15C are unsupervised machine learning clustering heat maps, according to an embodiment.

FIGS. 16A-16D are graphs of ROC curves classifying multifrequency impedance cytometry pulse data, according to an embodiment.

FIGS. 17A and 17B are flow charts of a method for signal acquisition and a method for digital signal processing, according to an embodiment.

FIG. 18 is a graph of two-stain and gated flow cytometry results, according to an embodiment.

FIGS. 19A-19C depict scatter plot comparisons between different frequencies for bipolar pulse data collected, according to an embodiment.

FIG. 20 is a flow diagram of a method for detecting probe microparticle(s), according to an embodiment.

FIG. 21 is a schematic view of a computer network in which embodiments may be implemented.

FIG. 22 is a block diagram illustrating an embodiment of a computer node in the computer network of FIG. 21.

### DETAILED DESCRIPTION

A description of example embodiments follows.

### Introduction

The growing need for personalized, accurate, and non-invasive diagnostic technology has resulted in significant advancements, from pushing current mechanistic limitations to innovative modality developments across various disease-related biomarkers. Clinical solutions, however, are lacking for timely analysis of multiple biomarkers simultaneously, which limits prognosis for patients suffering with complicated diseases or comorbidities. Here is conceived, fabricated, and validated a multifrequency impedance cytometry apparatus with novel frequency-sensitive barcoded microparticles, e.g., metal oxide Janus particles (MOJPs) as cell-receptor targeting agents. These microparticles are modulated by a metal oxide semi-coating layer which exhibit electrical property changes under specific frequencies in an electric field and are functionalized to target CD11b and CD66b membrane receptors on neutrophils. A multi-modal system with supervised machine learning and simultaneous high-speed video microscopy is used to classify two different leukocytes with immune-specific surface receptors targeted by MOJPs. As MOJPs target receptors and form neutrophil-MOJP conjugates, they flow in a microfluidic channel and multivariate, multifrequency electrical data is collected. High precision and sensitivity were determined based on the type of MOJPs conjugated with cells (>90% accuracy between neutrophil-MOJP conjugates versus cells alone). Remarkably, the design could differentiate the number of MOJPs conjugated per cell within the same MOJP class (>80% accuracy); which also improved comparing electrical responses across different MOJP types (>75% accuracy) as well. Such trends were consistent in individual samples and comparing consolidated data across multiple samples, demonstrating design robustness. Blood samples used for device testing were collected from Robert Wood Johnson University Hospital (RWJUH) (New Brunswick, NJ). The configuration may further expand to include more MOJP types targeting critical biomarker receptors in one sample and increase the modality's multiplexing potential.

Presently, several diseases are difficult to diagnose clinically due to lacking one highly correlated biomarker that can define its condition or state. This holds true for complicated, multifaceted diseases such as sepsis, acute kidney injury, many cancer types, and more. For these conditions, a promising class of biomarkers may arise from immune cell surface receptors, which demonstrate rapid and highly correlated expression density responses from pathogen contact or inflammatory conditions. Clinical research has pointed towards identifying these diseases through receptors such as CD64, C-type lectin, and CD66b on myeloid-derived cells or CTLA-4, CD18, and CD28 on T cells. However, higher diagnostic accuracy in complicated diseases only comes from measuring a panel of these receptor biomarkers simultaneously. The bottleneck to collect this critical receptor data comes a shortage of relatively inexpensive techniques measuring multiple cell membrane receptors in one sample, explaining why many rapidly progressing diseases remain elusive to diagnose.

To measure many disease-related receptors quickly, a promising solution may come from point-of-care, multiplexing machines, which can analyze multiple biomarkers simultaneously using the same investigative modality. Incorporating these targeting strategies on highly compartmentalized, point-of-care devices boasts several advantages including automated assay preparation and integrated signal processing. With these devices, diagnostics and disease outcomes may improve from smaller sample volumes required for miniaturized techniques, faster analysis, greater diagnostic accuracy by targeting multiple critical biomarkers, and increasing device availability across vast environmental and economical landscapes. From the multitude of point-of-care multiplexing techniques, impedance cytometry displays the highest potential for clinical translation. It can profile biological objects such as cells down to proteins and DNA nondestructively, and can provide fast electrical results. Additionally, fabrication upscaling makes it appealing for point-of-care settings. However, presently its ability to discern multiple species simultaneously is limited without the use of detection parallelization or sensitive targeting agents, of which few options have been conceived.

For novel impedance-sensitive targeting agents for impedance cytometry, a multiplexing modality using microparticles with varying metal oxide semi-coatings that are electrically identifiable using a multifrequency electric field was recently reported. These barcoded MOJPs can be differentiated both by metal oxide material, such as aluminum oxide, hafnium dioxide, and titanium dioxide, or layer thickness varying from 5 to 30 nm. Furthermore, these MOJPs may be antibody-functionalized to target multiple cell-surface receptors at once, providing a solution for high-receptor multiplexing detection using a singular multifrequency excitation and detection source.

Systems and methods for electronic barcoding of particles and a method to detect barcoded beads by impedance cytometry may be as described in Javanmard, U.S. Pat. No. 11,099,145, titled “Multiplexed assays,” which is herein incorporated by reference in its entirety.

Methods and systems for classifying biological particles using impedance flow cytometry may be as described in Javanmard et al., U.S. Pat. No. 11,604,133, titled “Use of multi-frequency impedance cytometry in conjunction with machine learning for classification of biological particles,” which is herein incorporated by reference in its entirety.

An electronic-sensing and magnetic-modulation (ESMM) biosensor device and methods of using the same, where the device incorporates electrical, microfluidic, and magnetic subsystems, may be as described in Hassan et al., U.S. Pat. No. 11,951,476 B2, titled “Electronic-sensing & magnetic-modulation (ESMM) biosensor for phagocytosis quantification in pathogenic infections and methods of use thereof,” which is herein incorporated by reference in its entirety.

A system and method for identifying groups of nanoparticles coated with metal oxides of varying thicknesses using supervised machine learning and a microfluidic impedance cytometer may be as described in Ashley et al., “Aluminum Oxide-Coated Particle Differentiation Employing Supervised Machine Learning and Impedance Cytometry,” 2022 IEEE 17^{th} International Conference on Nano/Micro Engineered and Molecular Systems (NEMS), 2022, pp. 211-216, which is herein incorporated by reference in its entirety.

Functionalization of anti-CD11b antibodies onto the surface of polystyrene microparticles semi-coated with Al₂O₃ may be as described in Ashley et al., “Functionalization of hybrid surface microparticles for in vitro cellular antigen classification,” Anal. Bioanal. Chem., 413, 555-564 (2021), which is herein incorporated by reference in its entirety.

A system and method for functionalizing barcoded probe microparticles with receptor-targeting antibodies may be as described in Ashley et al., “Antibody-functionalized aluminum oxide-coated particles targeting neutrophil receptors in a multifrequency microfluidic impedance cytometer” and “Antibody-functionalized aluminum oxide-coated particles targeting neutrophil receptors in a multifrequency microfluidic impedance cytometer—Electronic Supplemental Information (ESI),” Lab on a Chip 22.16 (2022): 3055-3066, which are herein incorporated by reference in their entireties.

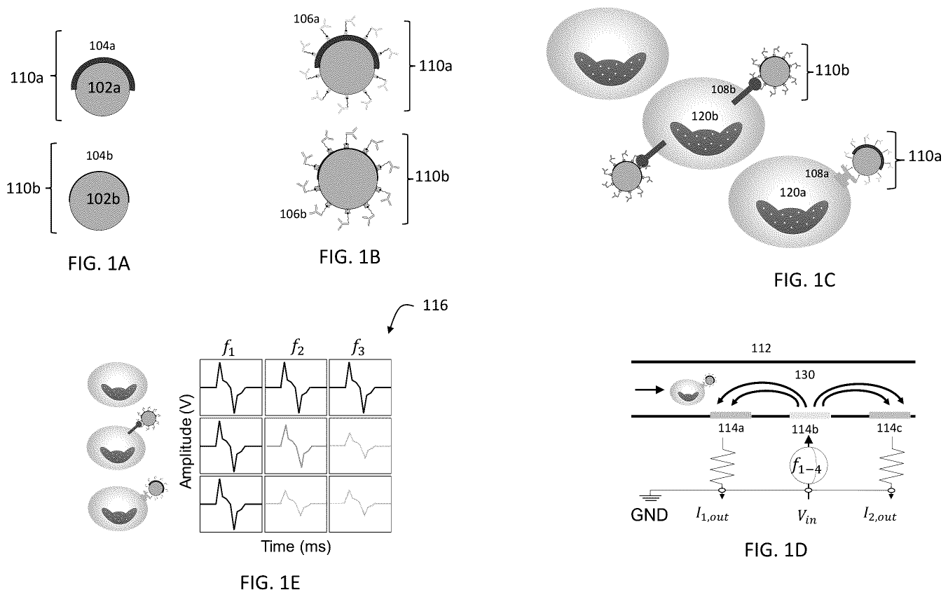

FIGS. 1A-1E are a graphical overview of electrically-sensitive biological entity receptor, e.g., cell membrane receptor, detection according to an embodiment. FIG. 1A illustrates example barcoded or probe microparticles 110a and 110b, e.g., microparticles having polystyrene cores 102a and 102b, respectively, according to an embodiment; other known core types are also suitable. In another embodiment, as shown in FIG. 1A, the probe microparticles 110a and 110b may include metal oxide semi-coatings or partial metal oxide coatings 104a and 104b, respectively. For instance, according to yet another embodiment, the probe microparticles 110a and 110b may be coated with different aluminum oxide (Al₂O₃) coatings, e.g., 20 nm and 10 nm, respectively; other known metal oxide types and/or sizes are also suitable. FIG. 1B illustrates the probe microparticles 110a and 110b of FIG. 1A functionalized with antibodies, which may be unique, 106a and 106b, respectively, according to an embodiment. In another embodiment, the antibodies 106a and 106b may be, e.g., anti-CD66b for 20 nm and anti-CD11b for 10 nm, respectively; other known antibody types are also suitable. FIG. 1C illustrates the functionalized probe microparticles 110a and 110b of FIG. 1B targeting receptors 108a and 108b, respectively, of corresponding biological entities 120a and 120b, e.g., inflammatory-related neutrophils or other cells, and forming entity-particle conjugates with receptor presence, according to an embodiment. FIG. 1D illustrates a channel 112, e.g., a microfluidic channel, cross-section where objects or entity-particle conjugates that are measured, e.g., individually, under flow using cytometry, e.g., microfluidic impedance cytometry, with multiple frequencies of electric field 130 applied, according to an embodiment. The multiple frequencies may be input and recordings produced via electrodes 114a-114c, e.g., gold coplanar electrodes. FIG. 1E depicts example graphs 116 of the multiple frequencies applied of FIG. 1D that isolate frequency responses, e.g., electrical signatures, specific (e.g., unique) to the probe microparticles 110a and 110b based on respective coating 104a and 104b thicknesses, according to an embodiment.

In an embodiment, described herein is a multi-modal validation of MOJP detection when conjugated to biological entities, e.g., neutrophils, using multifrequency impedance cytometry, e.g., multifrequency microfluidic impedance cytometry, and video microscopy, e.g., simultaneous high-speed video microscopy. FIGS. 1A-1E represent impedance detection, which demonstrates functionalizing the probe microparticles 110a and 110b (FIG. 1A), e.g., unique MOJPs, to target the receptors 108a and 108b (FIG. 1B), e.g., CD11b and CD66b receptors on neutrophils, using, e.g., a streptavidin (SAv)-biotin linker, according to an embodiment. When MOJPs conjugate to biological entities, e.g., cells, unique electrical properties may be recorded specific to frequency-sensitive amplitude shifts detected by the electric field 130 (FIG. 1D), e.g., a tuned multifrequency electric field, as shown in the graphs 116 (FIG. 1E). Further, high-speed video microscopy may be used in conjunction or coincidence with cytometry, e.g., microfluidic impedance cytometry, to confirm biological entity (e.g., cell)-MOJP conjugation. To achieve this, the Chronos 1.4 high-speed camera was used, which can reach frame rates up to 35,000 frames per second (fps) depending on resolution, along with internal storage up to 32 gigabytes (GBs), translating to approximately 16 seconds of real-time storage per experiment. Additionally, the camera has functioned in similar applications for capturing microfluidic characteristics, making it an ideal choice for measuring cell and cell-MOJP conjugates under microfluidic flow. Further, conjugate identities were labeled both by MOJP type and number of MOJPs conjugated per cell. Notably, in an embodiment, supervised machine learning accomplished high-accuracy alignment of individual conjugate identities from electrical shifts alone, and differentiated across MOJP type, the number of MOJPs conjugated per cell, and across measured samples.

### Exemplary Materials and Methods

### Exemplary Materials

SAv, phosphate buffered saline (PBS, 1× and 10×, pH=7.2), Ficoll-Paque density gradient, (3-Amino-propyl)triethoxysilane (APTES), and Roswell Park Memorial Institute (RPMI) medium 1640 were purchased through Sigma Aldrich® (St. Louis, MO). Biotinylated anti-CD11b monoclonal mouse antibody (>95% purity) was purchased through Thermo Fisher Scientific® (Waltham, MA). Biotinylated anti-CD66b was (>98% purity) was purchased through BioLegend® (San Diego, CA). A NE-300 syringe pump was purchased from SouthPointe Surgical Supply (Coral Springs, FL). LabVIEW® software was purchased and installed through National Instruments (Austin, TX). MATLAB® version 2020B was purchased and installed through MathWorks® (Natick, MA). A HF2LI lock-in amplifier and HF2TA current amplifier was purchased through Zurich Instruments® (Zurich, Switzerland). The VWR® Basic Inverted Microscope was purchased from VWR International (Radnor, PA). Unidentifiable human blood was obtained from RWJUH through an institutional review board (IRB) study. The Chronos 1.4 High Speed Camera was purchased from Kron Technologies (Vancouver, Canada). It should be noted that embodiments are not limited to the foregoing materials, instruments, and software; rather, any suitable materials, instruments, and/or software known in the art may be used.

### Microfabrication of Exemplary Probe Microparticles, Microelectrodes, and Microfluidic Channels

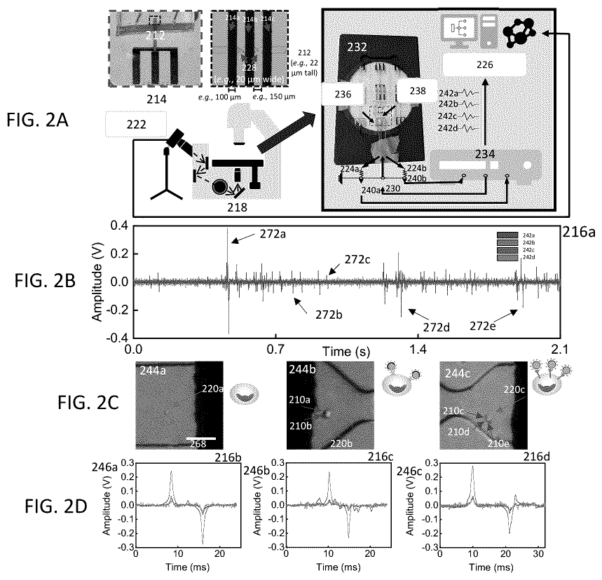

FIGS. 2A-2D depict an overview of multifrequency impedance cytometry and video microscopy, e.g., high-speed video microscopy, instrumentation and data collection, according to an embodiment. FIG. 2A illustrates electrodes 214a-214c (collectively indicated as 214), e.g., gold microelectrodes, with channels 212, e.g., polydimethylsiloxane (PDMS)-based microfluidic channels, staged above an inverted microscope 218 with a mounted video camera 222, e.g., a high-speed video camera, for simultaneous electrical-video recording, according to an embodiment. In another embodiment, the electrodes 214 may be bonded with current amplifying circuitry (not shown), with software 226 including a control program, e.g., LabVIEW, for data management and processing and machine learning for multi-variate differentiation. FIG. 2B depicts graphs 216a of biological entities and MOJP electrical response signals over four exemplary recorded voltage frequencies 242a, 242b, 242c, and 242d at 500 kHz (gray), 7.5 MHz (red), 8.3 MHz (blue), and 9 MHz (green), respectively, according to an embodiment; other known frequencies are also suitable. FIG. 2C depicts microscope images 244a-244c (scale bar 268=35 μm) captured from high-speed camera video recordings for biological entities 220a-220c, e.g., neutrophils, without 220a or with 220b-220c conjugated MOJPs 210a-210b and 210c-210e, e.g., 20 nm-MOJPs and 10 nm-MOJPs, respectively, according to an embodiment. FIG. 2D depicts graphs 216b-216d of corresponding species response signal bipolar pulse amplitudes 246a-246c for the images 244a-244c of FIG. 2C, according to an embodiment.

Previous reports have extensively described manufacturing barcoded microparticles. In an embodiment, a process of fabricating probe microparticles may include forming 3 μm polystyrene microparticles using nanosphere lithography. Then, according to another embodiment, 20 nm of gold may be semi-deposited above the particles using electron-beam deposition. Finally, in yet another embodiment, either 10 nm or 20 nm of aluminum oxide may be semi-coated above the gold layer using atomic layer deposition.

Additionally, example procedures for microfabricating coplanar electrodes and PDMS microchannels are described in previous articles. In an embodiment, photoresist-covered glass wafers may be exposed to ultraviolet (UV) light to render electrode dimensions, and 250 nm of chromium followed by 750 nm of gold may be sputtered on top to form the electrodes 214. Similarly, the channel(s) 212, e.g., microchannel structure(s), may be created above silicon wafers after UV exposure using photolithography. PDMS may be cured over microchannel pillars after APTES wafer treatment and cut out with a formed embedded channel design. Following O₂ plasma exposure, the channel(s) 212 and electrodes 214 may be bonded, with aligned channel focusing regions 228 between the electrodes 214. A constructed device may be adhered to a microscope stage 232 using tape and connected with a lock-in amplifier 234, e.g., a multifrequency lock-in amplifier, and the current amplifying circuit using silver conductive epoxy 236; the device may also include a contact pad 238, e.g., a gold contact pad. In addition, the lock-in amplifier 234 may perform signal demodulation, e.g., four-feature signal demodulation for the multiple frequencies 242a-242d.

### Probe Microparticle Functionalization

Functionalizing barcoded microparticles with receptor-targeting antibodies has also been defined in previous reports. According to an embodiment, 2 μL of SAv (0.1 mg/mL) may be mixed with both 200 μL of 20 nm aluminum oxide coated-Janus microparticle (MOJP) and 200 μL of 10 nm aluminum oxide coated-Janus microparticle solutions (6.0×10⁷ particles/mL each) and centrifuged/washed. After SAv adsorption to MOJPs, 10 μL of biotinylated anti-CD66b antibody (1 mg/mL in 1×PBS) may be added to the SAv-adsorbed 20 nm MOJPs solution (20 nmCD66b), while 10 μL of biotinylated anti-CD11b antibody (1 mg/mL in 1×PBS) may be added to the SAv-adsorbed 10 nm MOJPs solution (10 nmCD11b).

### Biological Entity Isolation and Probe Microparticle Conjugation

To isolate neutrophils from whole blood, blood samples from de-identified patients were obtained from RWJUH through an IRB-approved study. Once collected, blood was mixed with equal parts 1X PBS, and 1.8 mL of the mixture was combined with 2.4 mL of Ficoll-Paque density gradient. After centrifugation for 30 minutes at 400g, plasma, platelets, and red blood cells (RBCs) were separated by aspirating the supernatant and adding 3 mL of deionized (DI) water for 15 seconds to lyse non-neutrophil mononuclear cells. After adding 0.3 mL of 10×PBS for tonicity restoration, the solution was centrifuged for 5 minutes at 300g. This step was repeated until a neutrophil pellet formed, which was then re-suspended in RPMI 1640 with 50 L of cells to 5 mL of media.

After preparation, either 10 nmCD11b particles or 20 nmCD66b particles at 6.0×10⁷ particles/mL each were mixed with 1 mL of cells diluted in 1×PBS, followed by a 1-hour incubation. For samples without MOJPs added (cells alone), isolated neutrophils were diluted in 1×PBS and incubated for 1 hour.

### Multifrequency Impedance Cytometer Interfacing, Signal Acquisition, and Signal Processing

Referring again to FIG. 2A, in an embodiment, the middle electrode 214b may carry a voltage input 230, e.g., 10V, with the various input frequencies 242a-242d of, e.g., 500 kHz, 7.5 MHz, 8.3 MHz, and 9 MHz, while the exterior electrodes 214a and 214c may be grounded in series with resistors 224a and 224b, e.g., 10 kΩ resistors; other known voltages, frequencies, and/or resistor types are also suitable. As part of the software 226, a LabVIEW custom script, for instance, may acquire signals 240a-240b, which may include, e.g., converting current recordings to voltage and/or transimpedance amplification. Following this, the two input signals 240a and 240b may be subtracted through a differential amplifier (not shown), and sampled at, e.g., 250 kHz; other known sampling rates are also suitable. After signal acquisition 240a-240b, the four frequencies 242a-242d may be demodulated and isolated into distinct arrays (not shown) using the lock-in amplifier 234. As part of the software 226, digital filters using MATLAB, for instance, may be applied to normalize the signals 240a-240b and/or reduce background noise, including, e.g., a 4^{th} order Butterworth 20 Hz high-pass filter, a 4^{th} order Butterworth 100 kHz low-pass filter, and 1^{st} order Butterworth band-stop filters at 60 Hz and 120 Hz; other known filter types are also suitable. Further, electrical recordings (not shown) may be produced for each input frequency 242a-242d. A voltage threshold 15 times a noise standard deviation may collect either biological entity, e.g., neutrophil, or entity-probe microparticle conjugate data, including a difference between maximum and minimum voltage values recorded within 500 data points of a pulse threshold trigger determining pulse bipolar amplitude; other known voltage and/or pulse thresholds are also suitable.

### Multi-Modal High-Speed Video Microscopy

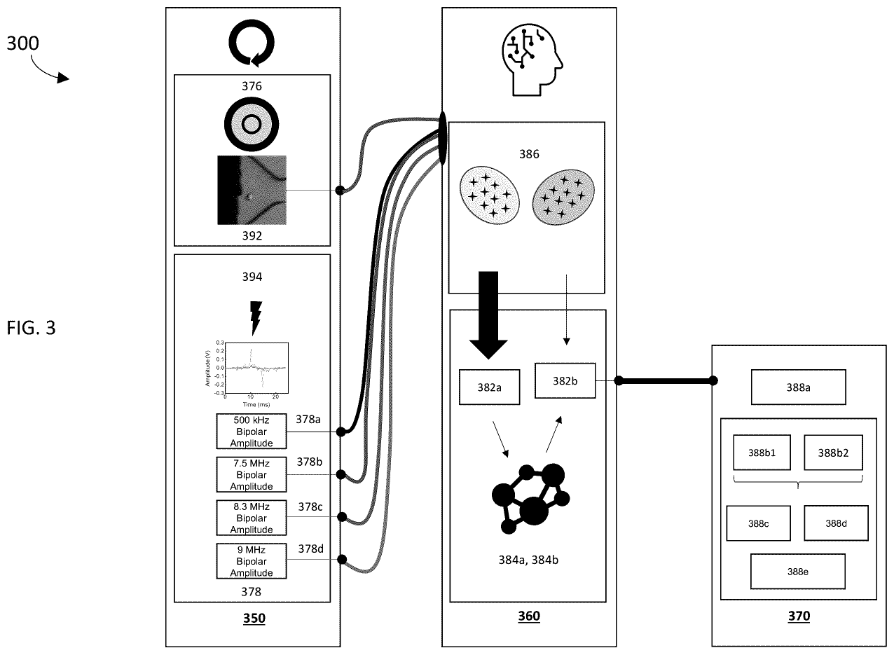

FIG. 3 is a block diagram of a system 300 for machine learning according to an embodiment. As shown in FIG. 3, in an embodiment, the system 300 includes a multi-modal data collection component 350, a machine learning (e.g., supervised machine learning) component 360, and an outcomes component 370. The data collection component 350 may include acquiring neutrophil-probe microparticle pulse data. The machine learning component 360 may include interpreting data with, e.g., the MATLAB Classification Learner application. The outcomes component 370 may include collecting deterministic outcomes.

Continuing with FIG. 3, in an embodiment, to acquire image data 376, a C-mount (not shown) may attach the video camera 222 (FIG. 2A), e.g., a Chronos 1.4 high-speed camera, to an eyepiece (not shown) of the inverted microscope 218 (FIG. 2A), set to, e.g., a 1280×360 resolution ratio, 4,500 recording fps, and a shutter rate of 25 s; other known resolution ratios, framerates, and/or shutter rates are also suitable. Together with camera specifications, a virtual Ethernet interface via Micro-USB connection (not shown), along with manufacturer support for a network IP address with the camera 222 over a local internet connection (not shown), may allow for remote camera access; other known connections are also suitable. The camera 222 may be accessed by, e.g., LabVIEW script control, as part of the software 226 (FIG. 2A), for starting and stopping recordings simultaneous to electrical recordings, thus ensuring data synchronization.

In an embodiment, as part of the software 226, a custom MATLAB program, for instance, may identify an electrical pulse threshold to isolate biological entity, e.g., neutrophil, pulses from residual RBCs and unconjugated MOJPs pulses. When neutrophil pulses are identified, a MATLAB script, for example, may extract video frames corresponding to a triggered electrical time point; identity classification 392 may be performed to assign frames to different arrays based on visualized entity-MOJP conjugation and, if conjugation is detected, how many probe microparticles are attached at once. A program may then store electrical data 394, e.g., bipolar pulse amplitude and pulse width data, from each demodulated frequency for the four exemplary frequency data inputs 242a-242d (FIG. 2A) in each classified array group.

### Machine Learning

Referring again to FIG. 3, in an embodiment, as part of the software 226, the MATLAB Classification Learner application, for instance, may be used to perform supervised machine learning training, validation, and/or testing across a myriad of support vector machine (SVM) model(s) 384a and/or neural network (NN) model(s) 384b; other known machine learning models are also suitable. The high-speed video microscopy images 376 may assign biological entity, e.g., neutrophil, or entity-MOJP conjugate identities. Further, bipolar amplitudes for each pulse across the four exemplary demodulated frequencies 242a-242d may be the four exemplary features 378a-378d (collectively indicated as 378) assigned to each data point. Two-group or two-identity comparison(s) 386, e.g., for neutrophils alone versus neutrophils with 10 nmCD11b MOJPs, may be assessed, with, e.g., 80% of selected data as model training data 382a and 20% of the selected data as model testing data 382b. In addition, metrics including accuracy 388a (e.g., differentiation accuracy), data counts 388b1 and 388b2 (e.g., true positive counts and false positive counts, respectively), sensitivity 388c, specificity 388d, and/or receiver operating characteristic (ROC) curves 388e may be reported from the highest testing accuracy model(s) 384a and 384b; other known metrics are also suitable. According to an embodiment, all SVM model(s) 384a had a box constraint value of 1, all NN model(s) 384b used a rectified linear unit activation function and had an iteration limit set to 1000, and both model types 384a and 384b performed prior data standardization.

### Exemplary Results and Discussion

### Multi-Modal Data Collection and Pulse Amplitude Representation

FIGS. 2B-2D show representative electrical pulse data and corresponding images extracted from saved high-speed video recordings with a multifrequency microfluidic impedance cytometer, according to an embodiment. In an embodiment, as shown in FIG. 2B with overlaid pulses for each exemplary frequency 242a-242d, neutrophil pulse amplitudes, e.g., 272d and 272e, are higher compared to other sample objects, making it ideal to use amplitude thresholding to isolate from competing analytes such as residual RBCs, e.g., 272b, and unconjugated MOJPs, e.g., 272c. According to another embodiment, as shown in FIG. 2C, with selected camera conditions, the images 244a-244c may have low but discernible light exposure while producing sharp frame-to-frame object clarity, which may be important when object identities are determined 392 (FIG. 3) from image frames, e.g., 376 (FIG. 3), in a video recording. FIG. 2C details different cell identities, such as individual neutrophils alone, e.g., 220a, compared to neutrophils 220b and 220c with different MOJPs attached at different positions 210a-210b and 210c-210e, respectively. In yet another example embodiment, corresponding expanded electrical pulse data for each of these objects is shown by FIG. 2D, and pulse amplitude data alone may show more pulse perturbations, which may also play a role in electrically confirming if MOJPs are conjugated to biological entities, e.g., cells.

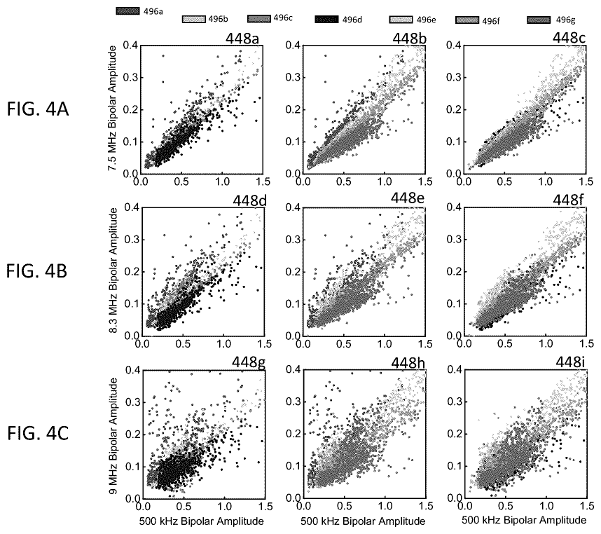

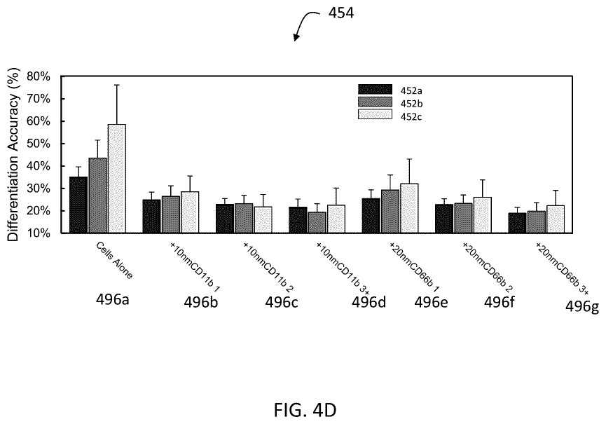

FIGS. 4A-4C illustrate relative bipolar amplitude scatter dot plots 448a-448i comparing bulk changes in response signal electrical data from different cell-particle configurations (versus an exemplary 500 kHz reference frequency), according to an embodiment; other known reference frequencies are also suitable. In an embodiment, cells 496a without conjugated probe microparticles (green), cells 496b with one conjugated 10 nm aluminum-oxide coated polystyrene particle functionalized to target CD11b receptor (10 nmCD11b, light blue), cells 496c with two 10 nmCD11b conjugates (blue), cells 496d with three or more 10 nmCD11b conjugates (dark blue), cells 496e with one conjugated 20 nm aluminum-oxide coated polystyrene particle functionalized to target CD66b receptor (20 nmCD66b, light orange), cells 496f with two 20 nmCD66b conjugates (orange), and cells 496g with three or more 20 nmCD66b conjugates (orange blue) were all observed and labeled from high-speed video microscopy.

As shown in FIG. 4A, in an embodiment, for 7.5 MHz, the plot 448a compares the cells alone 496a with all 10 nmCD11b-cell conjugates 496b-496d, the plot 448b compares the cells alone 496a with all 20 nmCD66b-cell conjugates 496e-496g, and the plot 448c compares all 10 nmCD11b-cell conjugates 496b-496d with all 20 nmCD66b-cell conjugates 496e-496g.

As shown in FIG. 4B, in an embodiment, for 8.3 MHz, the plot 448d compares the cells alone 496a with all 10 nmCD11b-cell conjugates 496b-496d, the plot 448e compares the cells alone 496a with all 20 nmCD66b-cell conjugates 496e-496g, and the plot 448f compares all 10 nmCD11b-cell conjugates 496b-496d with all 20 nmCD66b-cell conjugates 496e-496g.

As shown in FIG. 4C, in an embodiment, for 9 MHz, the plot 448g compares the cells alone 496a with all 10 nmCD11b-cell conjugates 496b-496d, the plot 448h compares the cells alone 496a with all 20 nmCD66b-cell conjugates 496e-496g, and the plot 448i compares all 10 nmCD11b-cell conjugates 496b-496d with all 20 nmCD66b-cell conjugates 496e-496g.

FIG. 4D depicts a histogram plot 454 of percentage change of average bipolar amplitude across all recorded samples for various cell and cell particle conjugate configurations recorded at frequencies 452a, 452b, and 452c of 7.5 MHz (black), 8.3 MHz (dark gray), and 9 MHz (light gray), respectively, relative to an exemplary 500 kHz reference bipolar amplitude, according to an embodiment.

In an embodiment, after this classification 392 (FIG. 3), changes in bipolar pulse amplitudes related to each object may be assigned and compared. FIGS. 4A-4C display bulk response signal amplitude data for each collected object across all conducted experiments with this design, according to an embodiment. As stated hereinabove, in an embodiment, the number of probe microparticles attached per cell were separated into different groups to evaluate sensitivity in electrically differentiating cell-particle conjugation. Here, it can be inferred that more MOJPs conjugated per cell may multiply the cell's frequency-sensitive amplitude shifts. Further, 20 nm MOJPs may experience a lower pulse amplitude shift at a lower frequency compared to 10 nm MOJPs. In an embodiment, as shown in FIGS. 4A-4C, regardless of degree of correlation, this may be affirmed from a slightly lower amplitude slope for the cell-20 nmCD66b amplitudes 496e-496g at an exemplary 7.5 MHz frequency in the plots 448a-448c versus the cell-10 nmCD11b amplitudes 496b-496d, which may no longer be apparent at an exemplary 8.3 MHz frequency in the plots 448d-448f, and average amplitude may be lower for the cell-10 nmCD11b pulses 496b-496d at 9 MHz in the plots 448g-448i versus the cell-20 nmCD66b data 496e-496g.

In an embodiment, as shown in FIGS. 4A-4D, when dividing by MOJP type and a number of those probe microparticles attached to cells, six different groups may be categorized; seven, e.g., 496a-496g (FIG. 4A), when including cells without any particles attached. According to another embodiment, as shown in FIG. 4D, large amplitude changes may appear across frequency spectra when normalized to an object's exemplary 500 kHz amplitude. In yet another embodiment, a first evident observation may be much larger normalized amplitudes for the cells without 496a any probe microparticles attached, which may factor into its high differentiation determined from machine learning results. According to an embodiment, a lower 7.5 MHz amplitude may be evident with the cells-20 nmCD66b conjugate groups 496e-496g, but it may also be shown that a number of MOJPs attached does indeed multiply their frequency effects, where relative bulk frequency reductions may occur for both 10 nmCD11b and 20 nmCD66b probe microparticles as a number of probe microparticles conjugated increases. In another embodiment, there may also be more similarity in normalized amplitude for the same number of particles conjugated across MOJP types (e.g., the cells with 496b one 10 nmCD11b versus the cells with 496e one 20 nmCD66b), although their polarization shifts towards their specific closest frequency may be lower than a corresponding amplitude of the other (7.5 MHz may be lower for the cells with 496e one 20 nmCD66b, 8.3 MHz may be lower for the cells with 496b one 10 nmCD11b). According to yet another embodiment, this relationship may be similar but may not hold completely accurately as a number of probe microparticles conjugated increases across samples, which may point towards a dynamic nature of MOJPs. In an embodiment, depending on if MOJPs are conjugated at a position where they are in contact, this may alter their frequency impedance shift and likewise their amplitude magnitude with the exemplary frequencies used in these experiments.

Machine Learning Comparing Cell-Conjugate Variants within Example Individual Samples

In an embodiment, machine learning was used on more specific cell-MOJP conjugate groups to better determine where signal changes were originating.

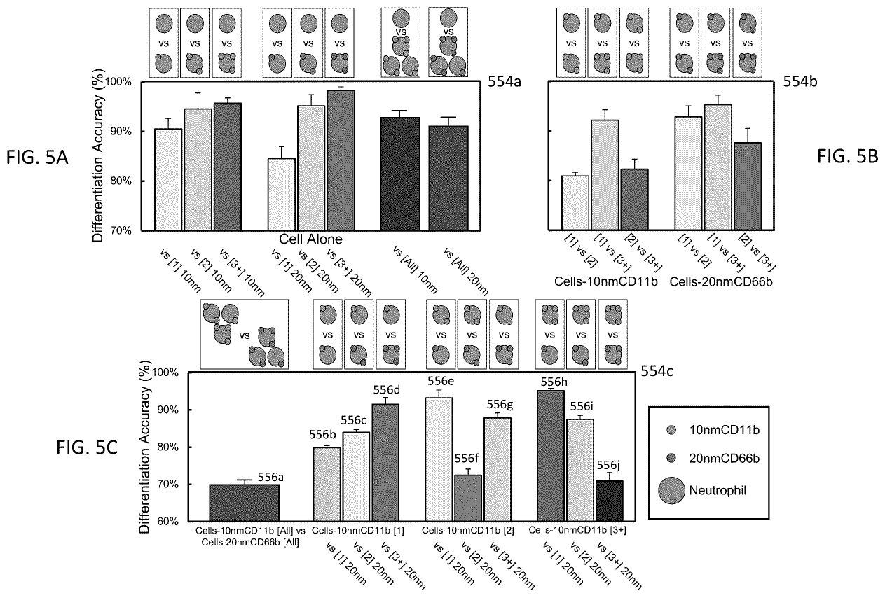

FIGS. 5A-5C depict histogram plots 554a-554c, respectively, of exemplary average reported accuracy differentiating different classified groups using their multifrequency electrical data and machine learning (n=3 samples), according to an embodiment. FIG. 5A depicts the histogram plot 554a of exemplary reported receptor presence: accuracy differentiating cells alone versus different cell-particle conjugate configurations by probe microparticle type and number of probe microparticles conjugated, according to an embodiment. FIG. 5B depicts the histogram plot 554b of exemplary reported electrical sensitivity: accuracy comparing ability to differentiate cell-particle conjugates by number of conjugated particles within the same probe microparticle type, according to an embodiment. FIG. 5C depicts the histogram plot 554c of exemplary reported multiplexing potential: accuracy differentiating cell-particle conjugates across probe microparticle types, according to an embodiment. In an embodiment, error bars in the histogram plots 554a-554c indicate standard error of the mean (S.E.M.).

In an embodiment, comparisons are shown as exemplary average accuracy across measured neutrophil samples (n=3). FIG. 5A illustrates exemplary accuracy in separating different numbers of probe microparticles attached relative to cells with no probe microparticles attached, according to an embodiment. In the histogram plot 554a, there was higher differentiation, as a number of probe microparticles conjugated increased for both groups, which points towards a compounding effect a number of probe microparticles has on signal amplitude at specific frequencies. This may only affirm where a high signal separation comes from when knowing if probe microparticles are attached, but it may also be useful to find differences within the same probe microparticle types, as this may quantify a degree of expression density on cells that could translate to clinical significance.

FIG. 5B illustrates exemplary accuracy in separating groups within the same probe microparticle class by a number of probe microparticles to a given cell, according to an embodiment. In the histogram plot 554b, the largest differences come from probe microparticle numbers that are nonconsecutive (e.g., 1 probe microparticle versus 3 or more probe microparticles attached), where degrees of separation between a consecutive number of probe microparticles conjugated are lower, but still all above 80% accuracy. While previously not considered to separate a number of probe microparticles attached, this may point towards a promising system sensitivity in identifying receptor expression density, where a proportional relationship would exist between cell-receptor expression and number of conjugated MOJPs.

In an embodiment, an ability to differentiate response signals by different types of MOJPs conjugated demonstrates certain embodiments' multiplexing potential and highest clinical significance. Further, dividing groups by a number of particles attached can help separate response signal data across types of MOJPs as well. FIG. 5C shows those comparisons, with each number of probe microparticles attached to cells being compared across MOJP type, according to an embodiment. Higher comparisons are seen in buckets 556c, 556d, 556e, 556g, 556h, and 556i across cohorts with greater differences in a number of probe microparticles attached, while the same number of probe microparticles attached had the lowest accuracy in buckets 556b, 556f, and 556j. Further limitations may also come from small amplitude shifts MOJPs provide at different frequencies relative to neutrophil pulse dominance, hindering sensitivity to differentiate them across MOJP types. Nonetheless, nearly all comparisons had accuracies higher versus only considering all number of particles conjugated to cells between MOJP types in bucket 556a, and were better confirmed by larger changes in pulse amplitude data at more representative applied frequencies. Table 1 below also summarizes exemplary reported average accuracy, area under the ROC curve (AUC ROC), sensitivity, and selectivity across different samples, according to an embodiment:

TABLE 1
Exemplary avg. machine learning results from comparisons across samples (±S.E.M.)

| | Accuracy | AUC ROCs | Sensitivity | Specificity |
|---|---|---|---|---|
| Cells alone vs Cells- | 92.7% ± 1.4% | 95.9% ± 2.8% | 93.23% ± 2.9% | 92.01% ± 3.5% |
| 10 nmCD11b All | | | | |
| Cells alone vs Cells- | 91.0% ± 1.8% | 95.4% ± 2.4% | 93.86% ± 1.3% | 87.60% ± 5.5% |
| 20 nmCD66b All | | | | |
| Cells-10 nmCD11b All vs | 69.9% ± 1.1% | 74.7% ± 2.5% | 51.76% ± 0.5% | 76.25% ± 5.5% |
| Cells-20 nmCD66b All | | | | |
| Cells alone vs Cells- | 90.5% ± 2.1% | 92.9% ± 1.2% | 84.29% ± 4.5% | 93.15% ± 1.6% |
| 10 nmCD11b [1] | | | | |
| Cells alone vs Cells- | 94.5% ± 3.2% | 94.1% ± 2.7% | 95.58% ± 2.8% | 89.33% ± 8.0% |
| 10 nmCD11b [2] | | | | |
| Cells alone vs Cells- | 95.7% ± 1.1% | 97.3% ± 1.5% | 93.42% ± 1.7% | 96.95% ± 1.6% |
| 10 nmCD11b [3+] | | | | |
| Cells alone vs Cells- | 84.5% ± 2.4% | 89.3% ± 2.6% | 86.22% ± 4.0% | 84.78% ± 4.0% |
| 20 nmCD66b [1] | | | | |
| Cells alone vs Cells- | 95.2% ± 2.2% | 96.9% ± 2.3% | 96.71% ± 0.8% | 95.87% ± 4.1% |
| 20 nmCD66b [2] | | | | |
| Cells alone vs Cells- | 98.3% ± 0.7% | 98.0% ± 1.0% | 98.01% ± 1.0% | 97.81% ± 1.7% |
| 20 nmCD66b [3+] | | | | |
| Cells-10 nmCD11b [1] vs | 80.9% ± 2.1% | 83.5% ± 0.8% | 78.23% ± 2.6% | 85.82% ± 3.7% |
| Cells-10 nmCD11b [2] | | | | |
| Cells-10 nmCD11b [1] vs | 92.2% ± 2.0% | 95.4% ± 3.3% | 89.91% ± 6.7% | 90.25% ± 4.0% |
| Cells-10 nmCD11b [3+] | | | | |
| Cells-10 nmCD11b [2] vs | 82.3% ± 2.3% | 87.5% ± 4.6% | 81.77% ± 5.8% | 83.20% ± 1.6% |
| Cells-10 nmCD11b [3+] | | | | |
| Cells-20 nmCD66b [1] vs | 92.8% ± 2.0% | 95.9% ± 1.9% | 84.81% ± 9.2% | 95.35% ± 1.2% |
| Cells-20 nmCD66b [2] | | | | |
| Cells-20 nmCD66b [1] vs | 95.3% ± 2.9% | 95.2% ± 4.4% | 90.85% ± 4.5% | 96.58% ± 2.9% |
| Cells-20 nmCD66b [3+] | | | | |
| Cells-20 nmCD66b [2] vs | 87.6% ± 5.1% | 92.2% ± 2.5% | 87.77% ± 3.6% | 92.38% ± 3.4% |
| Cells-20 nmCD66b [3+] | | | | |
| Cells-10 nmCD11b [1] vs | 79.8% ± 0.6% | 85.7% ± 3.2% | 83.67% ± 2.2% | 75.04% ± 2.5% |
| Cells-20 nmCD66b [1] | | | | |
| Cells-10 nmCD11b [1] vs | 84.0% ± 0.7% | 88.5% ± 2.0% | 79.95% ± 6.7% | 85.35% ± 2.2% |
| Cells-20 nmCD66b [2] | | | | |
| Cells-10 nmCD11b [1] vs | 91.5% ± 1.8% | 95.8% ± 1.9% | 83.56% ± 1.5% | 95.54% ± 2.4% |
| Cells-20 nmCD66b [3+] | | | | |
| Cells-10 nmCD11b [2] vs | 93.2% ± 2.1% | 95.2% ± 2.6% | 94.75% ± 2.8% | 90.73% ± 4.3% |
| Cells-20 nmCD66b [1] | | | | |
| Cells-10 nmCD11b [2] vs | 72.5% ± 1.6% | 72.2% ± 4.3% | 64.87% ± 5.1% | 80.98% ± 5.2% |
| Cells-20 nmCD66b [2] | | | | |
| Cells-10 nmCD11b [2] vs | 87.8% ± 1.4% | 92.9% ± 1.3% | 83.05% ± 3.2% | 88.42% ± 3.6% |
| Cells-20 nmCD66b [3+] | | | | |
| Cells-10 nmCD11b [3+]vs | 95.2% ± 0.6% | 97.5% ± 1.3% | 95.28% ± 0.7% | 94.51% ± 2.0% |
| Cells-20 nmCD66b [1] | | | | |
| Cells-10 nmCD11b [3+]vs | 87.5% ± 1.1% | 92.6% ± 1.3% | 87.00% ± 3.3% | 89.76% ± 2.7% |
| Cells-20 nmCD66b [2] | | | | |
| Cells-10 nmCD11b [3+]vs | 71.0% ± 2.2% | 75.3% ± 4.4% | 65.12% ± 4.1% | 73.84% ± 6.2% |
| Cells-20 nmCD66b [3+] | | | | |

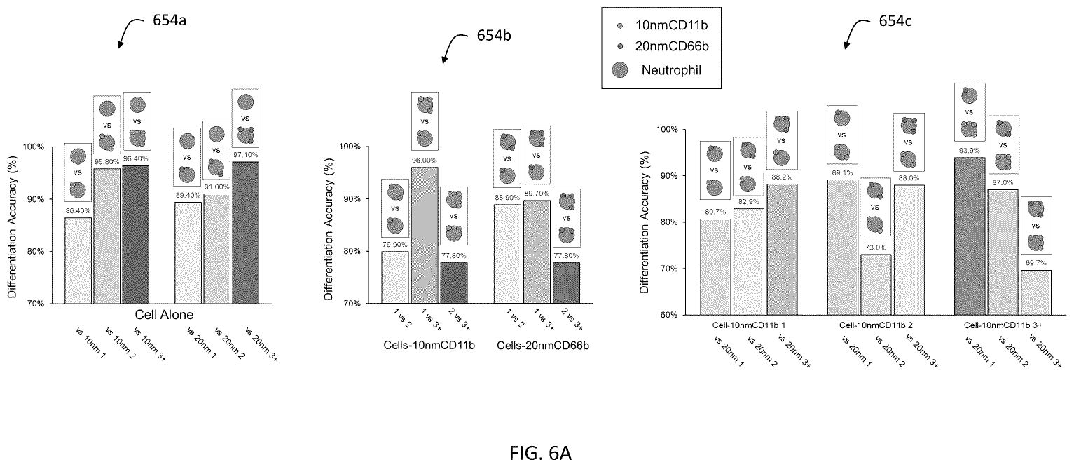

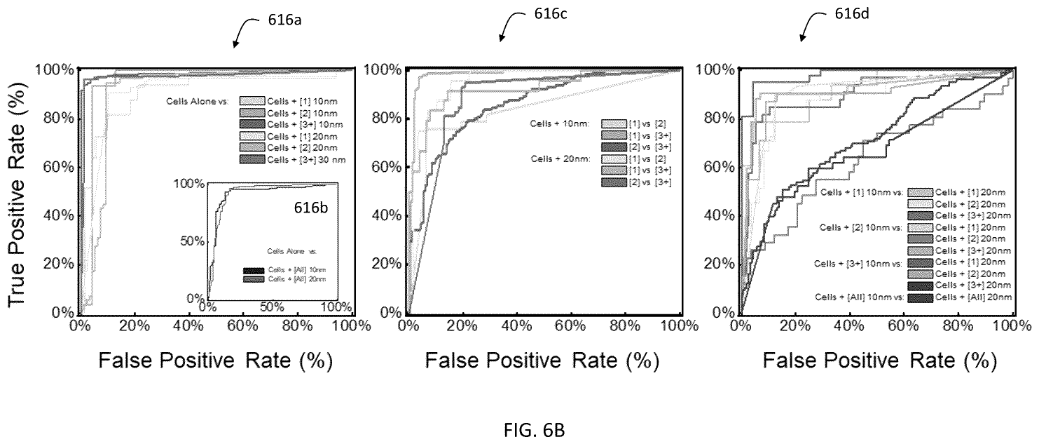

FIG. 6A depicts histogram plots 654a-654c of exemplary reported accuracy differentiating different classified groups using their multifrequency response signal electrical data and machine learning for a first individual sample, according to an embodiment. FIG. 6B depicts graphs 616a-616d of ROC curves of those corresponding comparisons for the first recorded sample of FIG. 6A, according to an embodiment.

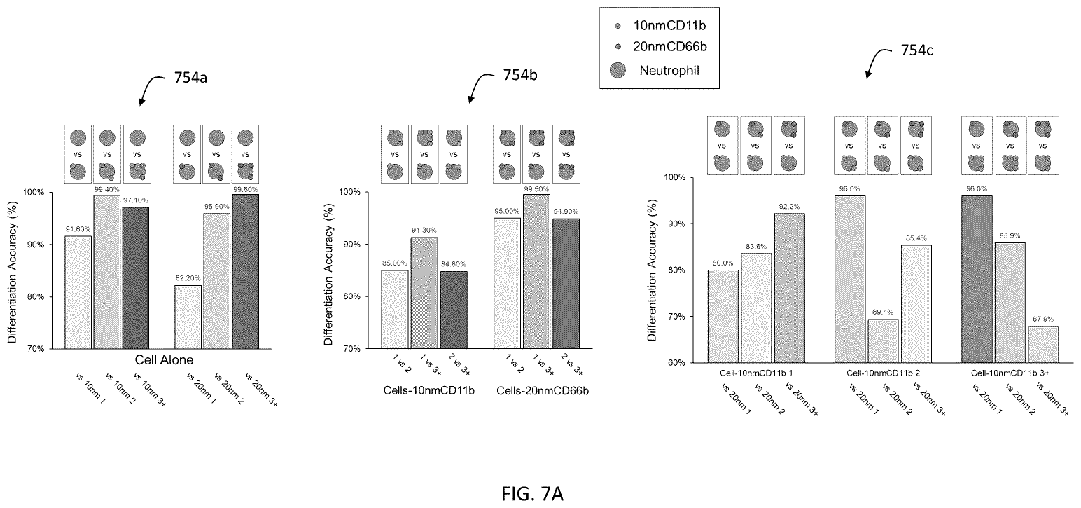

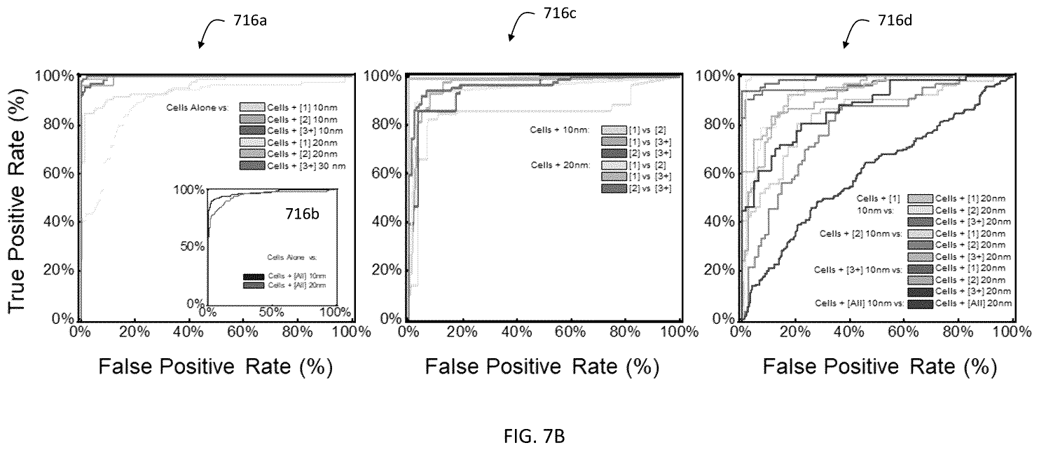

FIG. 7A depicts histogram plots 754a-754c of exemplary reported accuracy differentiating different classified groups using their multifrequency response signal electrical data and machine learning for a second individual sample, according to an embodiment. FIG. 7B depicts graphs 716a-716d of ROC curves of those corresponding comparisons for the second recorded sample of FIG. 7A, according to an embodiment.

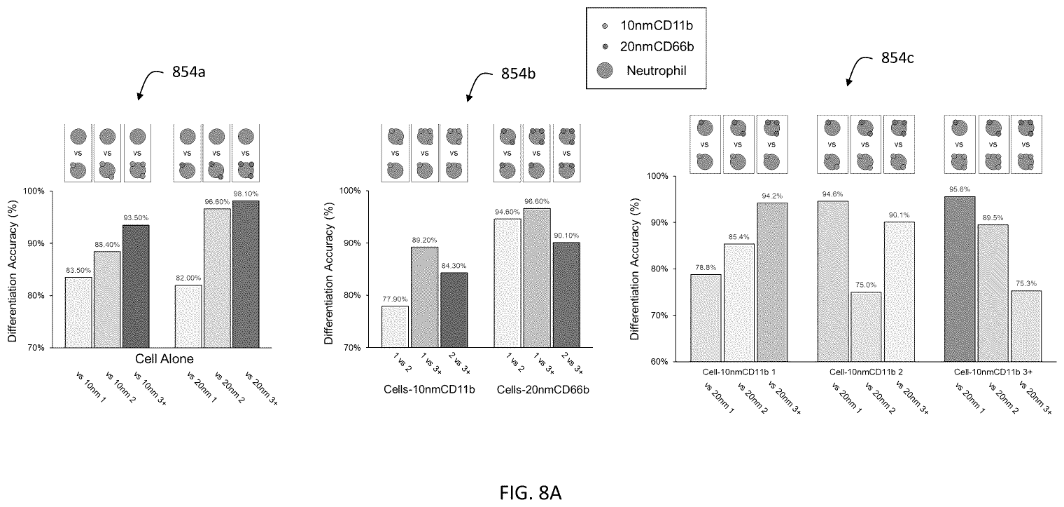

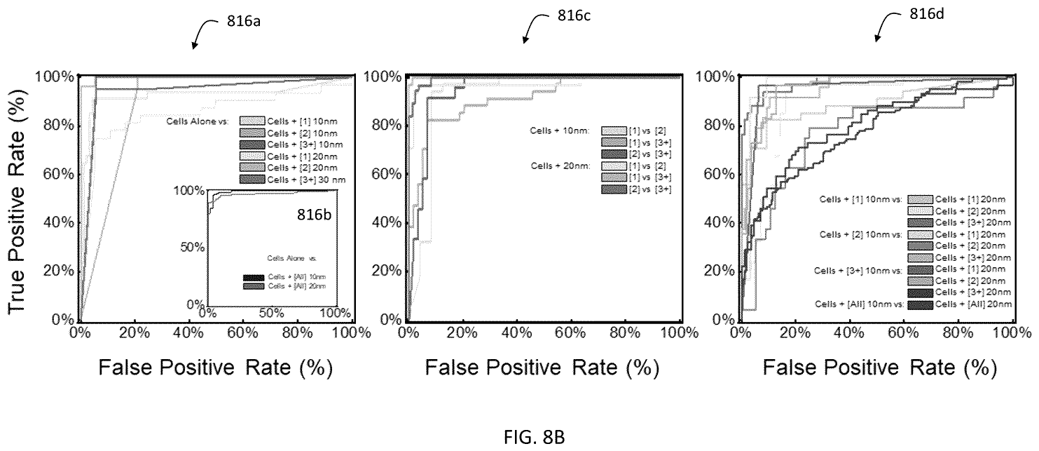

FIG. 8A depicts histogram plots 854a-854c of exemplary reported accuracy differentiating different classified groups using their multifrequency response signal electrical data and machine learning for a third individual sample, according to an embodiment. FIG. 8B depicts graphs 816a-816d of ROC curves of those corresponding comparisons for the third recorded sample of FIG. 8A, according to an embodiment.

In an embodiment, FIGS. 6A, 6B, 7A, 7B, 8A, and 8B may follow average trends closely labeling cells alone and cells with individual MOJPs conjugated.

### Evaluating Pooled Sample Data for Inter-Sample, Repeatable Accuracy

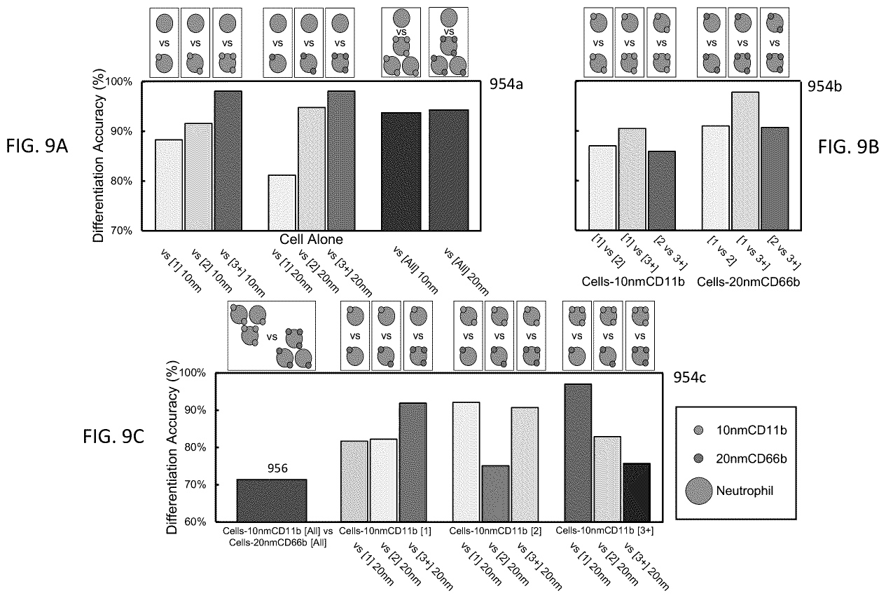

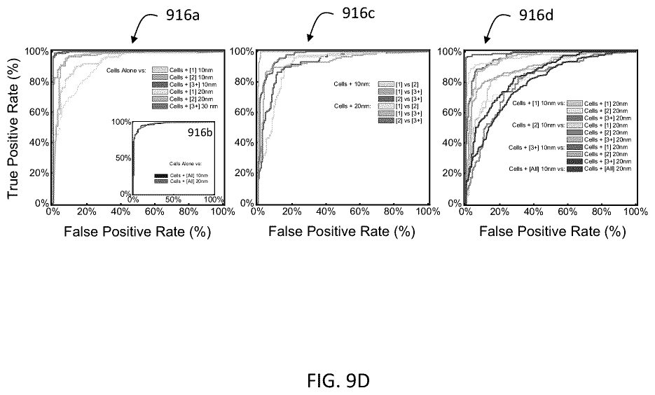

In an embodiment, after evaluating average machine learning outcomes from individual samples measured, the entire data across samples were combined to assess impacts of sample and device variability on sensitivity of electrically determining cell-MOJP conjugate groups. According to another embodiment, FIGS. 9A-9C and Table 2 below may showcase a similar methodology to FIGS. 5A-5C and Table 1, described hereinabove, but with single comparisons using the pooled data across samples to form exemplary individual machine learning evaluations.

TABLE 2
Exemplary machine learning results from comparisons of pooled sample data

| | Accuracy | AUC ROCs | Sensitivity | Specificity |
|---|---|---|---|---|
| Cells alone vs Cells-10 nmCD11b All | 93.8% | 97.6% | 95.4% | 88.0% |
| Cells alone vs Cells-20 nmCD66b All | 94.4% | 97.2% | 97.2% | 81.5% |
| Cells-10 nmCD11b All vs Cells- | 71.3% | 77.7% | 71.1% | 71.4% |
| 20 nmCD66b All | | | | |
| Cells alone vs Cells-10 nmCD11b [1] | 88.3% | 94.0% | 90.4% | 86.1% |
| Cells alone vs Cells-10 nmCD11b [2] | 91.6% | 97.8% | 90.6% | 92.6% |
| Cells alone vs Cells-10 nmCD11b [3+] | 98.1% | 99.9% | 97.5% | 99.1% |
| Cells alone vs Cells-20 nmCD66b [1] | 81.2% | 91.4% | 81.8% | 80.6% |
| Cells alone vs Cells-20 nmCD66b [2] | 94.8% | 96.8% | 97.2% | 90.8% |
| Cells alone vs Cells-20 nmCD66b [3+] | 98.1% | 99.9% | 99.5% | 96.3% |
| Cells-10 nmCD11b [1] vs Cells- | 87.0% | 91.0% | 89.5% | 84.6% |
| 10 nmCD11b [2] | | | | |
| Cells-10 nmCD11b [1] vs Cells- | 90.5% | 93.2% | 89.6% | 91.2% |
| 10 nmCD11b [3+] | | | | |
| Cells-10 nmCD11b [2] vs Cells- | 85.9% | 92.3% | 81.2% | 89.4% |
| 10 nmCD11b [3+] | | | | |
| Cells-20 nmCD66b [1] vs Cells- | 91.0% | 96.2% | 91.8% | 90.5% |
| 20 nmCD66b [2] | | | | |
| Cells-20 nmCD66b [1] vs Cells- | 97.8% | 99.8% | 95.5% | 99.0% |
| 20 nmCD66b [3+] | | | | |
| Cells-20 nmCD66b [2] vs Cells- | 90.7% | 97.2% | 89.9% | 91.3% |
| 20 nmCD66b [3+] | | | | |
| Cells-10 nmCD11b [1] vs Cells- | 81.7% | 87.6% | 77.2% | 86.4% |
| 20 nmCD66b [1] | | | | |
| Cells-10 nmCD11b [1] vs Cells- | 82.2% | 89.7% | 75.0% | 87.9% |
| 20 nmCD66b [2] | | | | |
| Cells-10 nmCD11b [1] vs Cells- | 91.9% | 96.8% | 87.7% | 94.2% |
| 20 nmCD66b [3+] | | | | |
| Cells-10 nmCD11b [2] vs Cells- | 92.1% | 96.7% | 92.3% | 91.8% |
| 20 nmCD66b [1] | | | | |
| Cells-10 nmCD11b [2] vs Cells- | 75.1% | 80.2% | 71.2% | 77.7% |
| 20 nmCD66b [2] | | | | |
| Cells-10 nmCD11b [2] vs Cells- | 90.7% | 94.9% | 87.2% | 92.7% |
| 20 nmCD66b [3+] | | | | |
| Cells-10 nmCD11b [3+] vs Cells- | 97.0% | 99.0% | 96.9% | 97.3% |
| 20 nmCD66b [1] | | | | |
| Cells-10 nmCD11b [3+] vs Cells- | 82.9% | 90.2% | 81.8% | 83.9% |
| 20 nmCD66b [2] | | | | |
| Cells-10 nmCD11b [3+] vs Cells- | 75.7% | 84.7% | 62.9% | 85.5% |
| 20 nmCD66b [3+] | | | | |

FIGS. 9A-9C depict histogram plots 954a-954c, respectively, of reported accuracy differentiating different classified groups using their multifrequency electrical data and machine learning when pooling data across all collected samples, according to an embodiment. FIG. 9A depicts the histogram plot 954a of reported receptor presence: accuracy differentiating cells alone versus different cell-particle conjugate configurations by particle type and number of particles conjugated, according to an embodiment. FIG. 9B depicts the histogram plot 954b of reported electrical sensitivity: accuracy comparing ability to differentiate cell-particle conjugates by the number of conjugated particles within the same particle type, according to an embodiment. FIG. 9C depicts the histogram plot 954c of reported multiplexing potential: accuracy differentiating cell-particle conjugates across particle types, according to an embodiment.

As shown in FIG. 9A, in an embodiment, cells alone versus any cell-MOJP iteration yields greater than 80% accuracy, which points towards an ability to measure MOJP presence on a binary level and can function as an individual biomarker detection mode. Expanding on MOJP presence, in another embodiment, FIG. 9B also illustrates similar accuracy trends comparing a number of MOJPs conjugated per cell when making calculations within the same MOJP class. As shown in FIG. 9B, greater than 85% accuracy was reported, and this defines impedance detection sensitivity within the same MOJP and likewise receptor expression density the MOJP targets. In an embodiment, FIG. 9C demonstrates multiplexing sensitivity by reporting machine learning accuracies across MOJP types. While a bulk comparison without considering a number of conjugated MOJPs per cell had accuracy at 71.3% in bucket 956, expanding to consider a number of conjugated MOJPs per cell then produced higher accuracies by pinpointing multiplied amplitude effects with increasing number of conjugated particles along with frequency-dependent amplitude shifts across MOJP type.

FIG. 9D plots ROC curves for each of the 24 unique group comparisons from the pooled cell-MOJP conjugate response signal data, with separate plots 916a-916d to group results similar to the respective accuracy bar plots 954a-954c from FIGS. 9A-9C, according to an embodiment. In an embodiment, while accuracy may be a significant metric for a model's function, ROC curves and AUC ROC may be a more discriminate paradigm, which may be more robust against unequal data size comparisons and overall a better clinical diagnostic evaluator. Given this, trends with accuracy and AUC ROC hold consistent with the pooled data, as all AUC ROCs are over 75% while many are over 95% (total plot area=100%). Likewise, models with high accuracy exhibited high AUC ROCs (cells alone versus cells with three or more 10 nmCD11b, cells with three or more 10 nmCD11b versus cells with one 20 nmCD66b), while the lowest accuracy comparisons also had the lowest AUC ROCs (cells with one or more 10 nmCD11b versus cells with one or more 20 nmCD66b, cells with three or more 10 nmCD11b versus cells with three or more 20 nmCD66b).

In an embodiment, with the pooled data having high model accuracies and AUC ROCs, this may demonstrate that electrical variability introduced between different sample impedance or baseline measurements from different impedance cytometers is insignificant compared to frequency-sensitive amplitude effects resulting from MOJPs conjugated to biological entities, e.g., cells. This may also show that machine learning models recognize these changes from unique barcoded amplitude changes from four exemplary applied frequencies and this unique response is robust compared to external noise contributors and inter-experimental variances. Overall, there may be insignificant sensitivity differences electrically identifying 10 nmCD11b MOJPs versus 20 nmCD66b MOJPs using a system of embodiments, as similar accuracies and AUC ROCs were reported independent of MOJP type.

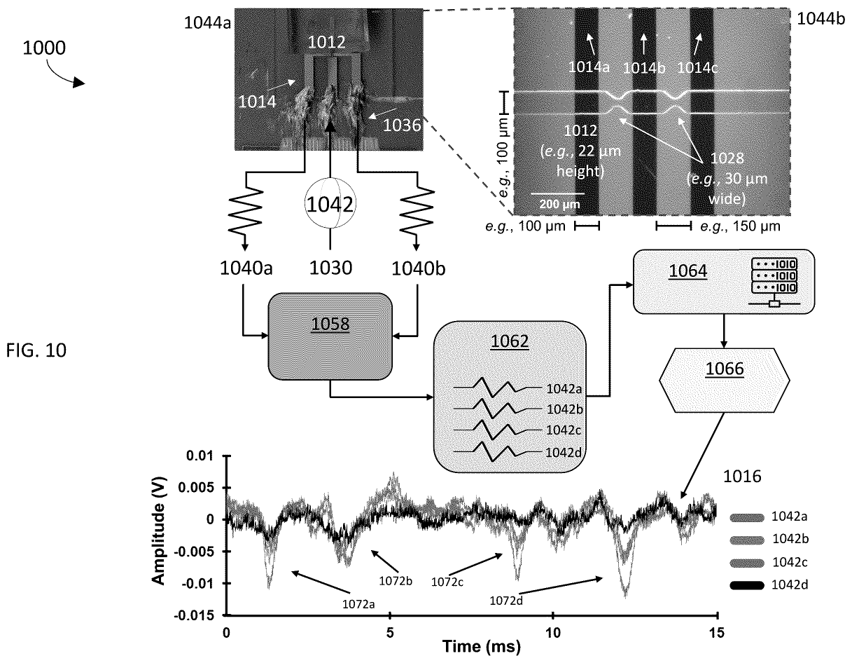

FIG. 10 depicts an overview of a multifrequency impedance cytometry device and probe microparticle detection scheme 1000, according to an embodiment. As shown in FIG. 10, in an embodiment, the scheme 1000 includes an image 1044a of a device with electrodes 1014a-1014c (collectively indicated as 1014), e.g., microfabricated gold electrodes, supporting channel(s) 1012, e.g., PDMS-based microfluidic channel(s). The electrodes 1014 may be connected to a custom printed circuit board (not shown) with silver conductive epoxy 1036 to interface a multifrequency voltage input 1030 and grounded electrode recordings 1040a-1040b through a lock-in amplifier (not shown). In addition, the scheme 1000 includes a microscope image 1044b of the channel(s) 1012 with focusing regions 1028 positioned between the electrodes 1014a-1014c, e.g., coplanar electrodes, which may increase detection sensitivity. The scheme 1000 also includes a differential amplifier 1058, signal demodulation 1062 from four exemplary input voltage frequencies 1042a-1042d (collectively indicated as 1042), data collection/acquisition 1064, and signal processing 1066, e.g., digital filtering, to produce response signal voltage data as shown in graph 1016. The graph 1016 plots representative time domain results of voltage data, with the four exemplary demodulated frequencies 1042a, 1042b, 1042c, and 1042d (e.g., 500 kHz, 1 MHz, 2 MHz, and 3 MHz, respectively) aligned to show pulses 1072a-1072d from isolated biological entities, e.g., neutrophils, flowing through the channel(s) 1012.

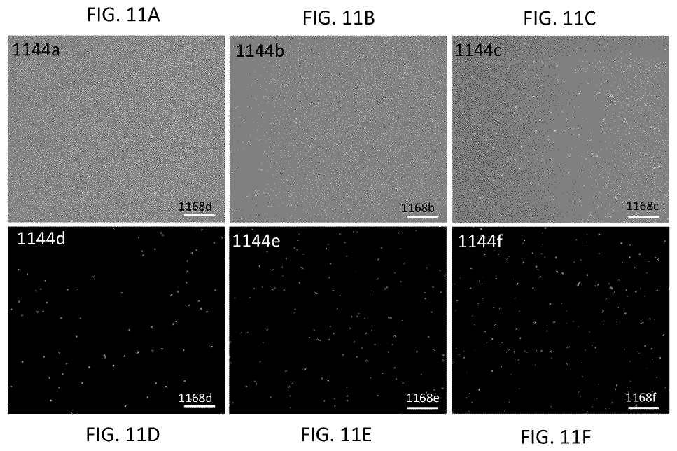

FIGS. 11A-11F depict brightfield images 1144a-1144c and false-colored fluorescence images 1144d-1144f of 30 nm probe microparticles functionalized with biotin-4-fluorescein dye (green) after SAv adsorption and 10 nm probe microparticles functionalized with biotinylated-Atto 655 (red) after SAv adsorption, according to an embodiment. In an embodiment, false coloring may be performed with ImageJ, with scale bars 1168a-1168f each indicating 40 μm.

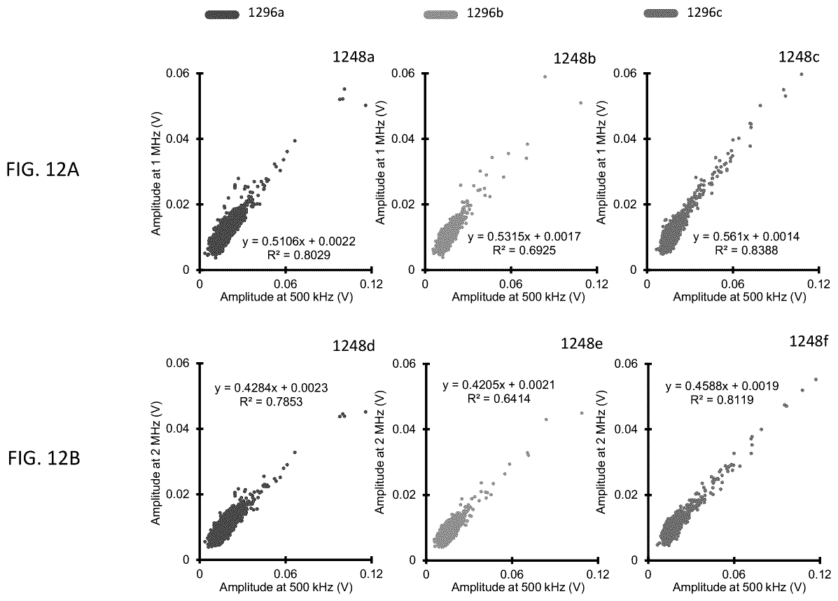

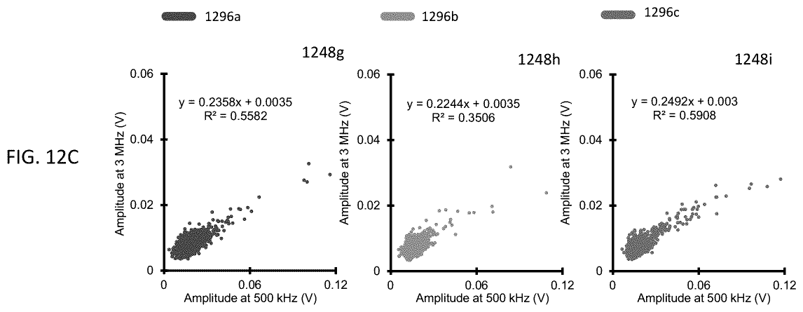

FIGS. 12A-12C illustrate scatter plots 1248a-1248i of bipolar amplitude data collected from multifrequency impedance cytometry, according to an embodiment. In an embodiment, the plot 1248a depicts bivariate data displaced across an exemplary higher frequency of 1 MHz compared to a lower 500 kHz exemplary reference frequency for isolated neutrophils alone 1296a. The plot 1248b depicts bivariate data displaced across an exemplary higher frequency of 1 MHz compared to a lower 500 kHz exemplary reference frequency for neutrophils combined 1296b with 10 nm MOJPs functionalized with anti-CD11b antibodies. The plot 1248c depicts bivariate data displaced across an exemplary higher frequency of 1 MHz compared to a lower 500 kHz exemplary reference frequency for neutrophils combined 1296c with 30 nm MOJPs functionalized with anti-CD66b antibodies.

According to an embodiment, the plot 1248d depicts bivariate data displaced across an exemplary higher frequency of 2 MHz compared to a lower 500 kHz exemplary reference frequency for the isolated neutrophils alone 1296a. The plot 1248e depicts bivariate data displaced across an exemplary higher frequency of 2 MHz compared to a lower 500 kHz exemplary reference frequency for the neutrophils combined 1296b with 10 nm MOJPs functionalized with anti-CD11b antibodies. The plot 1248f depicts bivariate data displaced across an exemplary higher frequency of 2 MHz compared to a lower 500 kHz exemplary reference frequency for the neutrophils combined 1296c with 30 nm MOJPs functionalized with anti-CD66b antibodies.

In an embodiment, the plot 1248g depicts bivariate data displaced across an exemplary higher frequency of 3 MHz compared to a lower 500 kHz exemplary reference frequency for the isolated neutrophils alone 1296a. The plot 1248h depicts bivariate data displaced across an exemplary higher frequency of 3 MHz compared to a lower 500 kHz exemplary reference frequency for the neutrophils combined 1296b with 10 nm MOJPs functionalized with anti-CD11b antibodies. The plot 1248i depicts bivariate data displaced across an exemplary higher frequency of 3 MHz compared to a lower 500 kHz exemplary reference frequency for the neutrophils combined 1296c with 30 nm MOJPs functionalized with anti-CD66b antibodies.

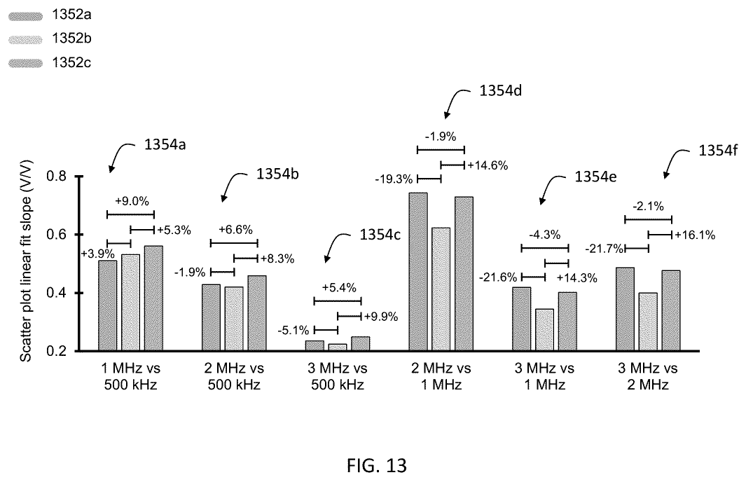

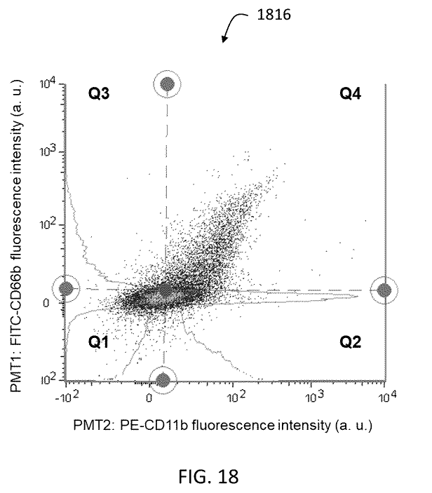

FIG. 13 depicts bar plots 1354a-1354f comparing line of best fit slopes from impedance cytometry pulse data across different frequencies, referenced in FIGS. 12A-12C (described hereinabove) and FIG. 18 (described hereinbelow), according to an embodiment. In an embodiment, the plots 1354a-1354f may depict isolated neutrophils alone 1352a, neutrophils combined 1352b with 10 nm MOJPs functionalized with anti-CD11b antibodies, and neutrophils combined 1352c with 30 nm MOJPs functionalized with anti-CD66b antibodies. Percentages may be percent change in linear regression slopes in reference to the leftmost species. Nomenclature may be shown as y-axis frequency versus x-axis frequency.

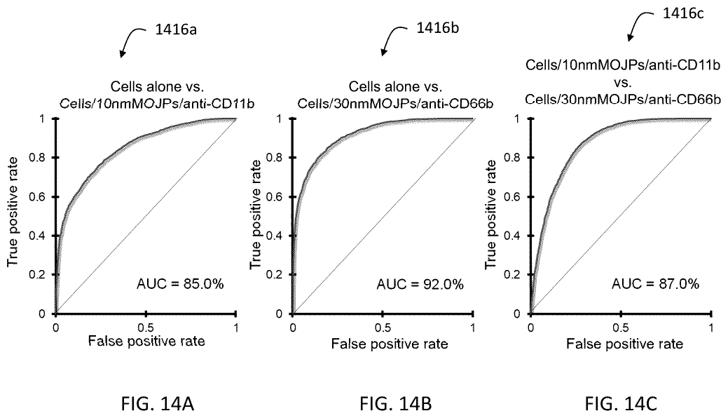

FIGS. 14A-14C are graphs 1416a-1416c of ROC curves classifying all multifrequency impedance cytometry pulse data, according to an embodiment. FIG. 14A depicts comparing isolated neutrophils (cells alone) to neutrophils combined with 10 nm MOJP) functionalized with anti-CD11b antibodies (cells/10 nm MOJP/anti-CD11b), according to an embodiment. FIG. 14B depicts cells alone versus neutrophils combined with 30 nm MOJPs functionalized with anti-CD66b antibodies (cells/30 nm MOJP/anti-CD66b), according to an embodiment. FIG. 14C depicts cells/10 nm MOJP/anti-CD11b vs. cells/30 nm MOJP/anti-CD66b.

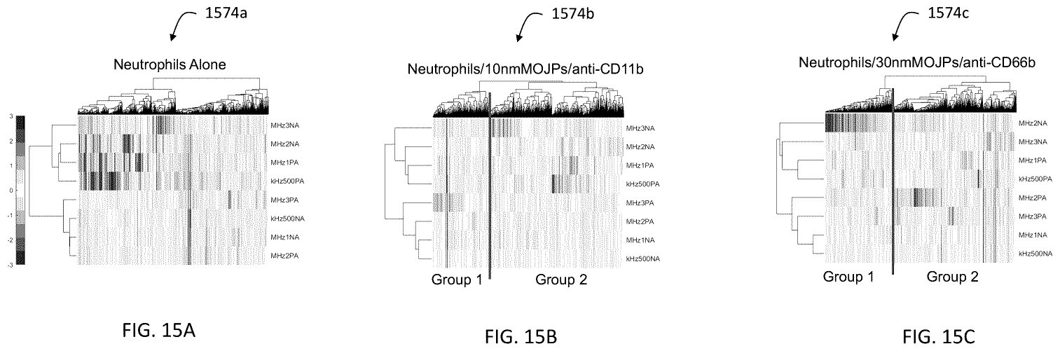

FIGS. 15A-15C are unsupervised machine learning clustering heat maps 1574a-1574c with positive (PA) and negative (NA) response signal amplitude data measured for exemplary voltage frequencies (500 kHz, 1 MHz, 2 MHz, and 3 MHz) and for different samples, according to an embodiment. FIG. 15A depicts a sample of isolated neutrophils without any functionalized MOJPs, according to an embodiment. FIG. 15B depicts a sample of isolated neutrophils with 10 nm MOJPs functionalized with anti-CD11b receptors, according to an embodiment. FIG. 15C depicts a sample of isolated neutrophils with 30 nm MOJPs functionalized with anti-CD66b receptors, according to an embodiment. In an embodiment, data points may be log normalized (red may be variance greater than average, blue may be variance less than average). Red lines may indicate highest degree separation between two groups.

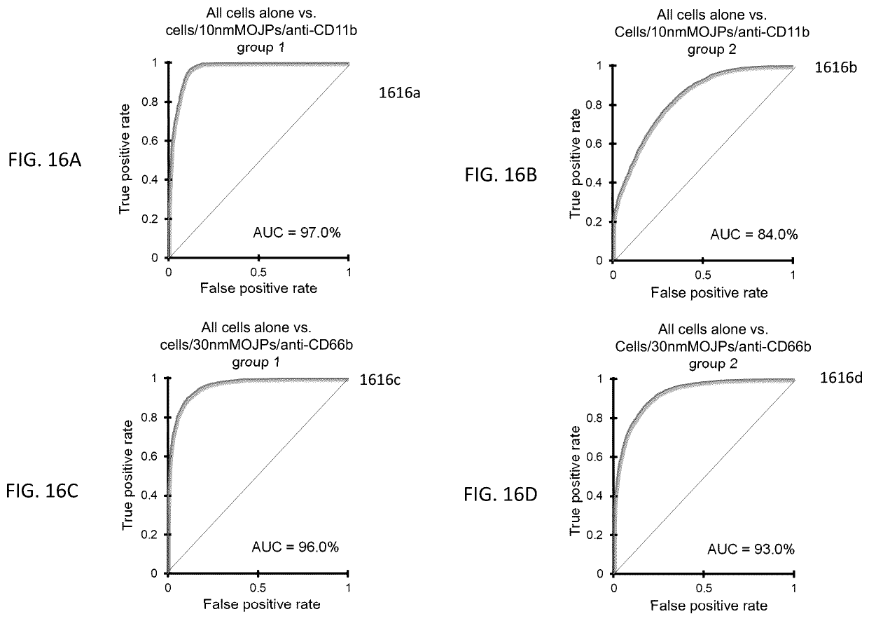

FIGS. 16A-16D are graphs 1616a-1616d of ROC curves classifying multifrequency impedance cytometry pulse data after potentially separating conjugated groups through unsupervised machine learning, according to an embodiment. In an embodiment, comparing all measured isolated neutrophils (all cells alone) data to neutrophils combined with 10 nm MOJPs functionalized with anti-CD11b antibodies (cells/10 nm MOJP/anti-CD11b) separated into two distinct groups through unsupervised clustering: FIG. 16A—group 1 (potentially cell-particle conjugate data and expressing CD11b) and FIG. 16B—group 2 (potentially cells which did not express CD11b). Cells alone versus neutrophils combined with 30 nm MOJPs functionalized with anti-CD66b antibodies (cells/30 nm MOJP/anti-CD66b) separated into two distinct groups through unsupervised clustering: FIG. 16C—group 1 (potentially cell-particle conjugate data and expressing CD66b) and FIG. 16D—group 2 (potentially cells which did not express CD66b). For group determinations, see FIGS. 15A-15C, described hereinabove.

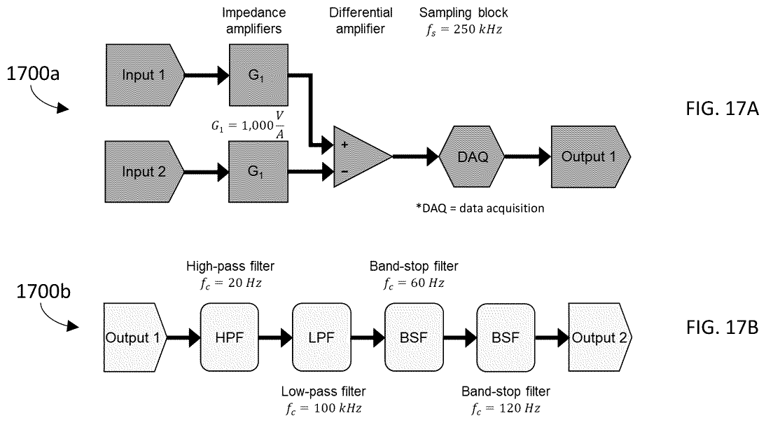

FIGS. 17A and 17B are flow charts of a method 1700a for signal acquisition and a method 1700b for digital signal processing to obtain electrical signatures from a multifrequency microfluidic impedance cytometer, according to an embodiment.

FIG. 18 is a graph 1816 of two-stain and gated flow cytometry results for CD11b expression (stained with phycoerythrin (PE)) and CD66b expression (stained with fluorescein isothiocyanate (FITC)) as reference receptor expression to compare with impedance response results from multifrequency impedance cytometry, according to an embodiment.

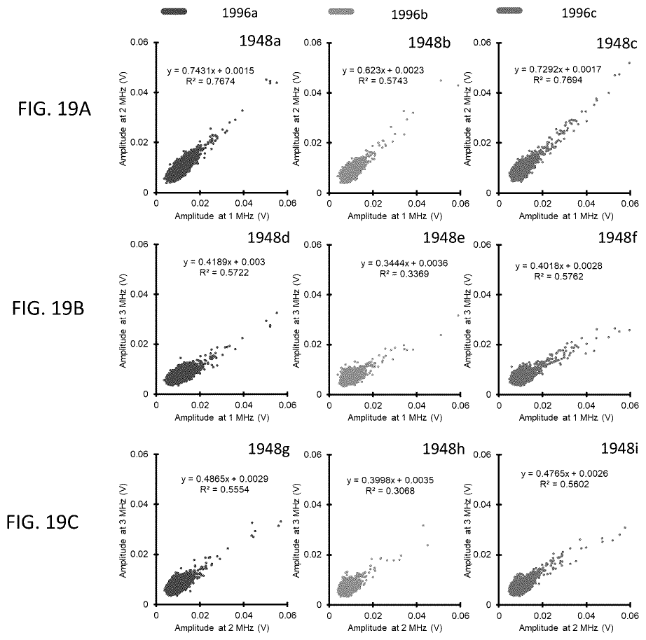

FIGS. 19A-19C depict scatter plot comparisons 1948a-1948i between different frequencies for bipolar pulse data collected for: isolated neutrophils alone 1996a in the plots 1948a, 1948d, and 1948g; neutrophils combined 1996b with 10 nm MOJPs functionalized with anti-CD11b antibodies in the plots 1948b, 1948e, and 1948h; and neutrophils combined 1996c with 30 nm MOJPs functionalized with anti-CD66b antibodies in the plots 1948c, 1948f, and 1948i, according to an embodiment.

In an embodiment, the plot 1948a depicts bivariate data displaced across an exemplary frequency of 2 MHz compared to an exemplary frequency of 1 MHz for isolated neutrophils alone 1996a. The plot 1948b depicts bivariate data displaced across an exemplary frequency of 2 MHz compared to an exemplary frequency of 1 MHz for neutrophils combined 1996b with 10 nm MOJPs functionalized with anti-CD11b antibodies. The plot 1948c depicts bivariate data displaced across an exemplary frequency of 2 MHz compared to an exemplary frequency of 1 MHz for neutrophils combined 1996c with 30 nm MOJPs functionalized with anti-CD66b antibodies.

According to an embodiment, the plot 1948d depicts bivariate data displaced across an exemplary frequency of 3 MHz compared to an exemplary frequency of 1 MHz for the isolated neutrophils alone 1996a. The plot 1948e depicts bivariate data displaced across an exemplary frequency of 3 MHz compared to an exemplary frequency of 1 MHz for the neutrophils combined 1996b with 10 nm MOJPs functionalized with anti-CD11b antibodies. The plot 1948f depicts bivariate data displaced across an exemplary frequency of 3 MHz compared to an exemplary frequency of 1 MHz for the neutrophils combined 1996c with 30 nm MOJPs functionalized with anti-CD66b antibodies.

In an embodiment, the plot 1948g depicts bivariate data displaced across an exemplary frequency of 3 MHz compared to an exemplary frequency of 2 MHz for the isolated neutrophils alone 1996a. The plot 1948h depicts bivariate data displaced across an exemplary frequency of 3 MHz compared to an exemplary frequency of 2 MHz for the neutrophils combined 1996b with 10 nm MOJPs functionalized with anti-CD11b antibodies. The plot 1948i depicts bivariate data displaced across an exemplary frequency of 3 MHz compared to an exemplary frequency of 2 MHz for the neutrophils combined 1996c with 30 nm MOJPs functionalized with anti-CD66b antibodies.

### Exemplary Conclusions

In an embodiment, electrically sensitive barcoded probe microparticles were measured with multifrequency impedance cytometry, with simultaneous high-speed video microscopy that enabled supervised machine learning to identify cell-probe microparticle configurations using their multi-parameter frequency responses. A high accuracy was found comparing 10 nmCD11b-cell and 20 nmCD66b-cell conjugates to cells alone (both >90%). In yet another embodiment, while bulk comparisons of 10 nmCD11b-cell and 20 nmCD66b-cell conjugates were lower (69.8% accuracy), expansion of electrical signatures to a number of probe microparticles attached within MOJP types increased accuracy in identifying objects electrically (up to 98% accuracy). This demonstrated an ability to characterize receptor expression density, as a number of probe microparticles per cell could also be counted. Further, high accuracy was maintained both with replicate experiments and after pooling all sample data together.

### Exemplary Method Embodiment

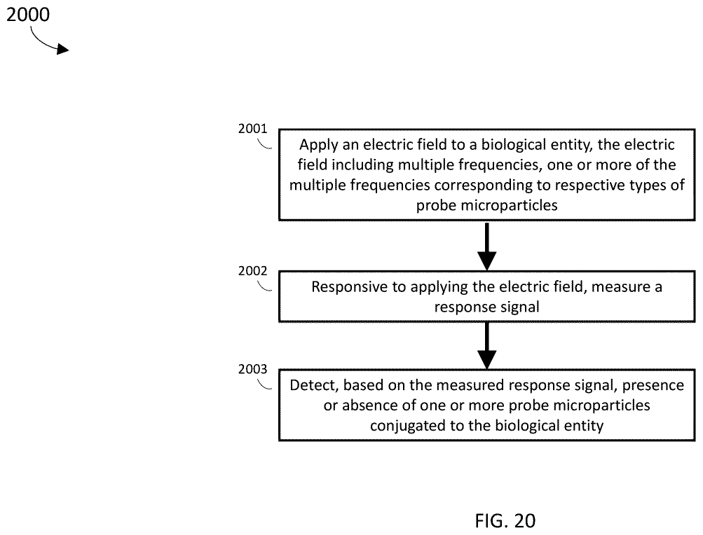

FIG. 20 is a flow diagram of a method 2000 for detecting probe microparticle(s), e.g., 110a-110b (FIG. 1A) or 210a-201e (FIG. 2C), according to an embodiment. The method 2000 starts at step 2001 by applying an electric field, e.g., 130 (FIG. 1D), 230 (FIG. 2A), 1030 (FIG. 10), to a biological entity, e.g., 120a-120b (FIG. 1C) or 220a-220c (FIG. 2C), such as a cell. The electric field includes multiple frequencies, e.g., 242a-242d (FIG. 2A) or 1042a-1042d (FIG. 10). One or more of the multiple frequencies correspond to respective types of probe microparticles. Each type of probe microparticle includes a core, e.g., 102a-102b (FIG. 1A), and at least a partial metal oxide coating, e.g., 104a-104b (FIG. 1A). Further, each type of probe microparticle is configured to produce a response corresponding to a respective frequency and conjugate to a corresponding type of biological entity. Responsive to applying the electric field, at step 2002, the method 2000 measures a response signal, e.g., 240a-240b (FIG. 2A) or 1040a-1040b (FIG. 10). At step 2003, the method 2000 then detects, based on the measured response signal, a presence or absence of probe microparticle(s) conjugated to the biological entity.

In an embodiment, the method 2000 may further include, responsive to detecting the presence of the probe microparticle(s), determining a property or properties of the biological entity. According to another embodiment, the method 2000 may further include classifying the biological entity based on the property or properties.

In an embodiment, the method 2000 may further include demodulating, e.g., 1062 (FIG. 10), the measured response signal into multiple signals corresponding to the multiple frequencies.

According to an embodiment of the method 2000, the biological entity may be flowed through a detector in a conductive medium, and the detector may be used to apply the electric field and measure the response signal. In another embodiment of the method 2000, the detector may be a multifrequency impedance cytometer, and the measured response signal may be an impedance response.

In an embodiment of the method 2000, for a given type of probe microparticle, the type of probe microparticle may be configured to conjugate to the corresponding type of biological entity by binding to surface receptor(s), e.g., 108a-108b (FIG. 1C), associated with the corresponding type of biological entity. According to another embodiment of the method 2000, the surface receptor(s) may include antigen(s) and the type of probe microparticle may be functionalized with an antibody or antibodies, e.g., 106a-106b (FIG. 1C), configured to bind the antigen(s).

According to an embodiment of the method 2000, for a given type of probe microparticle, the metal oxide may be an aluminum oxide, a hafnium oxide, or a titanium oxide.

In an embodiment of the method 2000, for a given type of probe microparticle, the metal oxide coating may have a thickness in a range of about 5 nm-30 nm.

According to an embodiment of the method 2000, each of the one or more of the multiple frequencies corresponding to respective types of probe microparticles may be in a range of about 1 MHz-30 MHz and another of the multiple frequencies may be a reference frequency in a range of about 100 kHz-1 MHz.

In an embodiment of the method 2000, each of the one or more of the multiple frequencies may be selected based on a property or properties of the respective type of probe microparticle. According to another embodiment of the method 2000, the property or properties include metal oxide material and/or coating thickness.

According to an embodiment of the method 2000, a machine learning model, e.g., 384a-384b (FIG. 3), may be used to detect the presence or absence of the probe microparticle(s). In another embodiment of the method 2000, the machine learning model may include a neural network model, a SVM model, a naïve Bayes model, and/or an ensemble classifier model. According to yet another embodiment of the method 2000, the machine learning model may be configured to analyze feature(s), e.g., 378a-378d (FIG. 3), associated with the measured response signal. The feature(s) may include at least bipolar amplitude.

### Computer Support

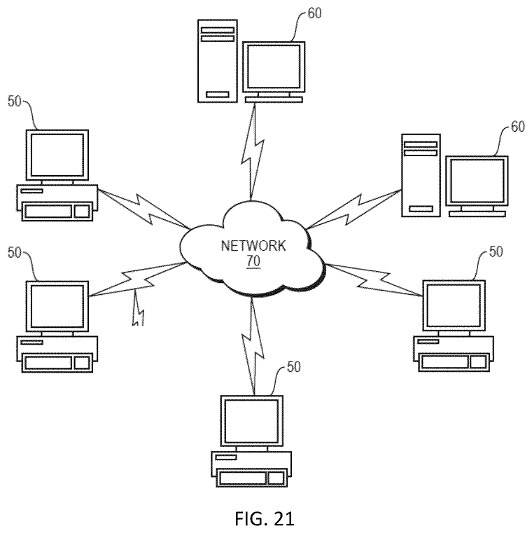

FIG. 21 is a schematic view of a computer network in which embodiments may be implemented.

Client computer(s)/devices 50 and server computer(s) 60 provide processing, storage, and input/output (I/O) devices executing application programs and the like. Client computer(s)/device(s) 50 can also be linked through communications network 70 to other computing devices, including other client device(s)/processor(s) 50 and server computer(s) 60. Communications network 70 can be part of a remote access network, a global network (e.g., the Internet), cloud computing servers or service, a worldwide collection of computers, local area or wide area networks, and gateways that currently use respective protocols (e.g., TCP/IP, Bluetooth®, etc.) to communicate with one another. Other electronic device/computer network architectures are suitable.

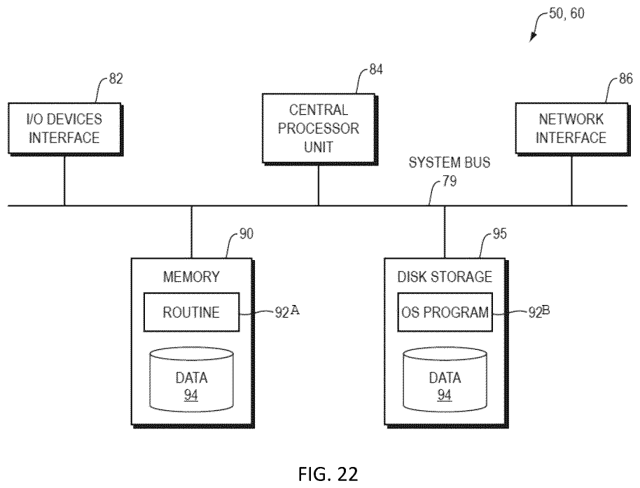

FIG. 22 is a block diagram illustrating an example embodiment of a computer node (e.g., client processor(s)/device(s) 50 or server computer(s) 60) in the computer network 70 of FIG. 21. Each computer node 50, 60 contains system bus 79, where a bus is a set of hardware lines used for data transfer among components of a computer or processing system. The system bus 79 is essentially a shared conduit that connects different elements of a computer system (e.g., processor, disk storage, memory, I/O ports, network ports, etc.) that enables transfer of information between the elements. Attached to the system bus 79 is an I/O devices interface 82 for connecting various input and output devices (e.g., keyboard, mouse, display(s), printer(s), speaker(s), etc.) to the computer node 50, 60. A network interface 86 allows the computer node to connect to various other devices attached to a network (e.g., the network 70 of FIG. 21). A memory 90 provides volatile storage for computer software instructions 92a and data 94a used to implement an embodiment of the present disclosure (e.g., the method 2000 of FIG. 20). A disk storage 95 provides non-volatile storage for the computer software instructions 92b and data 94b used to implement an embodiment of the present disclosure. A central processor unit 84 is also attached to the system bus 79 and provides for execution of computer instructions.

In one embodiment, the processor routines 92a-92b and data 94a-94b are a computer program product (generally referenced as 92), including a computer readable medium (e.g., a removable storage medium such as DVD-ROM(s), CD-ROM(s), diskette(s), tape(s), etc.) that provides at least a portion of the software instructions for the disclosure system. Computer program product 92 can be installed by any suitable software installation procedure, as is well known in the art. In another embodiment, at least a portion of the software instructions may also be downloaded over a cable, communication, and/or wireless connection. In other embodiments, the disclosure programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present disclosure routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network (such as the network 70 of FIG. 21). In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of the computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium, and the like.

In other embodiments, the program product 92 may be implemented as a so-called Software as a Service (SaaS), or other installation or communication supporting end-users.

Embodiments or aspects thereof may be implemented in the form of hardware including but not limited to hardware circuitry, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, hardware, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

The teachings of all patents, applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

### REFERENCES

Abdel-Salam, B. K. A., Ebaid, H., 2014. Expression of CD11b and CD18 on polymorphonuclear neutrophils stimulated with interleukin-2. Cent.-Eur. J. Immunol. 39, 209-215.
Adib, M., Ostadi, V., Navaei, F., Fosoul, F. S., Oreizi, F., Shokouhi, R., Bakhshiani, Z., 2007. Evaluation of CD11b Expression on Peripheral Blood Neutrophils for Early Detection of Neonatal Sepsis. Iran. J. Allergy Asthma Immunol. 93-96.
Alegre, M.-L., Frauwirth, K. A., Thompson, C. B., 2001. T-cell regulation by CD28 and CTLA-4. Nat. Rev. Immunol. 1, 220-228.
Ashley, B. K., Hassan, U., 2021a. Point-of-critical-care diagnostics for sepsis enabled by multiplexed micro and nanosensing technologies. WIREs Nanomedicine Nanobiotechnology 13, e1701.
Ashley, B. K., Hassan, U., 2021b. Time-domain signal averaging to improve microparticles detection and enumeration accuracy in a microfluidic impedance cytometer. Biotechnol. Bioeng. 118, 4428-4440.
Ashley, B. K., Sui, J., Javanmard, M., Hassan, U., 2022. Antibody-functionalized aluminum oxide-coated particles targeting neutrophil receptors in a multifrequency microfluidic impedance cytometer. Lab. Chip 22, 3055-3066.
Ashley, B. K., Sui, J., Javanmard, M., Hassan, U., 2022. Aluminum Oxide-Coated Particle Differentiation Employing Supervised Machine Learning and Impedance Cytometry, in: 2022 IEEE 17^{th} International Conference on Nano/Micro Engineered and Molecular Systems (NEMS), pp. 211-216.
Ashley, B. K., Sui, J., Javanmard, M., Hassan, U., 2021. Functionalization of hybrid surface microparticles for in vitro cellular antigen classification. Anal. Bioanal. Chem. 413, 555-564.
Baraket, A., Lee, M., Zine, N., Sigaud, M., Bausells, J., Errachid, A., 2017. A fully integrated electrochemical biosensor platform fabrication process for cytokines detection. Biosens. Bioelectron., Special Issue Selected papers from the 26th Anniversary World Congress on Biosensors (Part II) 93, 170-175.
Biron, B. M., Ayala, A., Lomas-Neira, J. L., 2015. Biomarkers for Sepsis: What is and What Might Be? Biomark. Insights 10s4, BMI.S29519.
Boissière-Michot, F., Jacot, W., Fraisse, J., Gourgou, S., Timaxian, C., Lazennec, G., 2020. Prognostic Value of CXCR2 in Breast Cancer. Cancers 12, 2076.
Chang, K. C., Burnham, C.-A., Compton, S. M., Rasche, D. P., Mazuski, R., SMcDonough, J., Unsinger, J., Korman, A. J., Green, J. M., Hotchkiss, R. S., 2013. Blockade of the negative co-stimulatory molecules PD-1 and CTLA-4 improves survival in primary and secondary fungal sepsis. Crit. Care 17, R85.
Chao, C., Jin, X., Fan, X., 2020. Evolution of thin-liquid films surrounding bubbles in microfluidics and their impact on the pressure drop and fluid movement. Langmuir 36, 15102-15111.
Chiffoleau, E., 2018. C-Type Lectin-Like Receptors As Emerging Orchestrators of Sterile Inflammation Represent Potential Therapeutic Targets. Front. Immunol. 9.
Cihalova, K., Hegerova, D., Jimenez, A. M., Milosavljevic, V., Kudr, J., Skalickova, S., Hynek, D., Kopel, P., Vaculovicova, M., Adam, V., 2017. Antibody-free detection of infectious bacteria using quantum dots-based barcode assay. J. Pharm. Biomed. Anal. 134, 325-332.
Duke, D. J., Knast, T., Thethy, B., Gisler, L., Edgington-Mitchell, D., 2019. A low-cost high-speed CMOS camera for scientific imaging. Meas. Sci. Technol. 30, 075403.
Ellett, F., Jorgensen, J., Marand, A. L., Liu, Y. M., Martinez, M. M., Sein, V., Butler, K. L., Lee, J., Irimia, D., 2018. Diagnosis of sepsis from a drop of blood by measurement of spontaneous neutrophil motility in a microfluidic assay. Nat. Biomed. Eng. 2, 207-214.
Farooq, A., Colón-Franco, J. M., 2019. Procalcitonin and Its Limitations: Why a Biomarker's Best Isn't Good Enough. J. Appl. Lab. Med. 3, 716-719.
Gao, D.-N., Yang, Z.-X., Qi, Q.-H., 2015. Roles of PD-1, Tim-3 and CTLA-4 in immunoregulation in regulatory T cells among patients with sepsis. Int. J. Clin. Exp. Med. 8, 18998-19005.
Hassan, U., Ghonge, T., Jr, B. R., Patel, M., Rappleye, M., Taneja, I., Tanna, A., Healey, R., Manusry, N., Price, Z., Jensen, T., Berger, J., Hasnain, A., Flaugher, E., Liu, S., Davis, B., Kumar, J., White, K., Bashir, R., 2017. A point-of-care microfluidic biochip for quantification of CD64 expression from whole blood for sepsis stratification. Nat. Commun. 8, 15949.
Hung, S.-K., Lan, H.-M., Han, S.-T., Wu, C.-C., Chen, K.-F., 2020. Current Evidence and Limitation of Biomarkers for Detecting Sepsis and Systemic Infection. Biomedicines 8, 494.
Ilie, M., Hofman, V., Ortholan, C., Bonnetaud, C., Coëlle, C., Mouroux, J., Hofman, P., 2012. Predictive clinical outcome of the intratumoral CD66b-positive neutrophil-to-CD8-positive T-cell ratio in patients with resectable nonsmall cell lung cancer. Cancer 118, 1726-1737.
Khan, S. Q., Khan, I., Gupta, V., 2018. CD11b Activity Modulates Pathogenesis of Lupus Nephritis. Front. Med. 5, 52.
Kim, M. H., Choi, J. H., 2020. An Update on Sepsis Biomarkers. Infect. Chemother. 52, 1-18.
Lam, B., Das, J., Holmes, R. D., Live, L., Sage, A., Sargent, E. H., Kelley, S. O., 2013. Solution-based circuits enable rapid and multiplexed pathogen detection. Nat. Commun. 4, 2001.
Lehmann, L. E., Hunfeld, K.-P., Emrich, T., Haberhausen, G., Wissing, H., Hoeft, A., Stuber, F., 2008. A multiplex real-time PCR assay for rapid detection and differentiation of 25 bacterial and fungal pathogens from whole blood samples. Med. Microbiol. Immunol. (Berl.) 197, 313-324.
Lin, Z., Lin, SY., Xie, P. et al. Rapid Assessment of Surface Markers on Cancer Cells Using Immuno-Magnetic Separation and Multi-frequency Impedance Cytometry for Targeted Therapy. Sci Rep 10, 3015 (2020).
Ma, T., Sun, S., Li, B., Chu, J., 2019. Piezoelectric peristaltic micropump integrated on a microfluidic chip. Sens. Actuators Phys. 292, 90-96.
Oh, D.-J., 2020. A long journey for acute kidney injury biomarkers. Ren. Fail. 42, 154-165.
Patel, K., Sebastiani, G., 2020. Limitations of non-invasive tests for assessment of liver fibrosis. JHEP Rep. 2, 100067.
Petchakup, C., Hutchinson, P. E., Tay, H. M., Leong, S. Y., Li, K. H. H., Hou, H. W., 2021. Label-free quantitative lymphocyte activation profiling using microfluidic impedance cytometry. Sens. Actuators B Chem. 339, 129864.
Petersen, L. E., Schuch, J. B., de Azeredo, L. A., Baptista, T. S. A., Motta, J. G., do Prado, A. D., Bauer, M. E., 2019. Characterization of senescence biomarkers in rheumatoid arthritis: relevance to disease progression. Clin. Rheumatol. 38, 2909-2915.
Saleh, O. A., Sohn, L. L., 2003. Direct detection of antibody-antigen binding using an on-chip artificial pore. Proc. Natl. Acad. Sci. U.S.A 100, 820-824.
Schmidt, T., Brodesser, A., Schnitzler, N., Griiger, T., Brandenburg, K., Zinserling, J., Zündorf, J., 2015. CD66b Overexpression and Loss of C5a Receptors as Surface Markers for Staphylococcus aureus-Induced Neutrophil Dysfunction. PLOS ONE 10, e0132703.
Schmidt, T., Zündorf, J., Griiger, T., Brandenburg, K., Reiners, A.-L., Zinserling, J., Schnitzler, N., 2012. CD66b overexpression and homotypic aggregation of human peripheral blood neutrophils after activation by a gram-positive stimulus. J. Leukoc. Biol. 91, 791-802.
Sheneef, A., Mohamed, T., Boraey, N. F., Ashry, M., 2017. Neutrophil CD11b, CD64 and Lipocalin-2: Early Diagnostic Markers of Neonatal Sepsis. Egypt. J. Immunol. 24, 29-36.
Sui, J., Xie, P., Lin, Z., Javanmard, M., 2020. Electronic classification of barcoded particles for multiplexed detection using supervised machine learning analysis. Talanta 215, 120791.
Sun, A., Wambach, T., Venkatesh, A. G., Hall, D. A., 2014. A low-cost smartphone-based electrochemical biosensor for point-of-care diagnostics, in: 2014 IEEE Biomedical Circuits and Systems Conference (BioCAS) Proceedings. Presented at the 2014 IEEE Biomedical Circuits and Systems Conference (BioCAS) Proceedings, pp. 312-315.
Sun, L. L., Leo, Y. S., Zhou, X., Ng, W., Wong, T. I., Deng, J., 2020. Localized surface plasmon resonance based point-of-care system for sepsis diagnosis. Mater. Sci. Energy Technol. 3,274-281.
Talukder, N., Furniturewalla, A., Le, T., Chan, M., Hirday, S., Cao, X., Xie, P., Lin, Z., Gholizadeh, A., Orbine, S., Javanmard, M., 2017. A portable battery powered microfluidic impedance cytometer with smartphone readout: towards personal health monitoring. Biomed. Microdevices 19, 36.
Tang, J., Lin, G., Langdon, W. Y., Tao, L., Zhang, J., 2018. Regulation of C-Type Lectin Receptor-Mediated Antifungal Immunity. Front. Immunol. 9.
Uddin, R., Burger, R., Donolato, M., Fock, J., Creagh, M., Hansen, M. F., Boisen, A., 2016. Lab-on-a-disc agglutination assay for protein detection by optomagnetic readout and optical imaging using nano and micro-sized magnetic beads. Biosens. Bioelectron. 85, 351-357.
van de Groep, K., Bos, M. P., Savelkoul, P. H. M., Rubenjan, A., Gazenbeek, C., Melchers, W. J. G., van der Poll, T., Juffermans, N. P., Ong, D. S. Y., Bonten, M. J. M., Cremer, O. L., on behalf of the MARS consortium, 2018. Development and first evaluation of a novel multiplex real-time PCR on whole blood samples for rapid pathogen identification in critically ill patients with sepsis. Eur. J. Clin. Microbiol. Infect. Dis. 37, 1333-1344.
Wagner, K., A. Sami, M., Norton, C., McCoy, J., Hassan, U., 2021. Profiling single-cell level phagocytic activity distribution with blood lactate levels. RSC Adv. 11, 21315-21322.
Wang, X., Wang, Y., Yang, X., Li, B., Chu, J., 2023. Highly Uniform Droplet Generation Enabled by Microfluidic Impact Printing and Its Application in Lyophilized Microbeads Preparation. IEEE Trans. Biomed. Eng. 70, 573-580.
Watkins, N. N., Hassan, U., Damhorst, G., Ni, H., Vaid, A., Rodriguez, W., Bashir, R., 2013. Microfluidic CD4+ and CD8+ T Lymphocyte Counters for Point-of-Care HIV Diagnostics Using Whole Blood. Sci. Transl. Med. 5, 214ra170-214ra170.
Weirich, E., Rabin, R. L., Maldonado, Y., Benitz, W., Modler, S., Herzenberg, Leonard A., Herzenberg, Leonore A., 1998. Neutrophil CD11b expression as a diagnostic marker for early-onset neonatal infection. J. Pediatr. 132, 445-451.
Wen, Y., Parikh, C. R., 2021. Current concepts and advances in biomarkers of acute kidney injury. Crit. Rev. Clin. Lab. Sci. 58, 354-368.
Xie, P., Cao, X., Lin, Z., Javanmard, M., 2017. Top-down fabrication meets bottom-up synthesis for nanoelectronic barcoding of microparticles. Lab. Chip 17, 1939-1947.
Yeh, E.-C., Fu, C.-C., Hu, L., Thakur, R., Feng, J., Lee, L. P., 2017. Self-powered integrated microfluidic point-of-care low-cost enabling (SIMPLE) chip. Sci. Adv. 3, e1501645.
Zeitoun, A. A. H., Gad, S. S., Attia, F. M., Maziad, A. S. A., Bell, E. F., 2010. Evaluation of neutrophilic CD64, interleukin 10 and procalcitonin as diagnostic markers of early- and late-onset neonatal sepsis. Scand. J. Infect. Dis. 42, 299-305.
Zhang, S., Li, Z., Wei, Q., 2020. Smartphone-based cytometric biosensors for point-of-care cellular diagnostics. Nanotechnol. Precis. Eng. 3, 32-42.

What is claimed is:

1. A method for detecting one or more probe microparticles, the method comprising:
applying an electric field to a biological entity, the electric field including multiple frequencies, one or more of the multiple frequencies corresponding to respective types of probe microparticles, each type of probe microparticle including a core and at least a partial metal oxide coating, and each type of probe microparticle configured to: (i) produce a response corresponding to a respective frequency and (ii) conjugate to a corresponding type of biological entity;
responsive to applying the electric field, measuring a response signal; and
detecting, based on the measured response signal, presence or absence of one or more probe microparticles conjugated to the biological entity.

2. The method of claim 1, further comprising:
responsive to detecting the presence of the one or more probe microparticles, determining one or more properties of the biological entity.

3. The method of claim 2, further comprising:
classifying the biological entity based on the one or more properties.

4. The method of claim 1, wherein the biological entity is a cell.

5. The method of claim 1, further comprising:
demodulating the measured response signal into multiple signals corresponding to the multiple frequencies.

6. The method of claim 1, further comprising flowing the biological entity through a detector in a conductive medium, and wherein the applying the electric field and the measuring the response signal are performed using the detector.

7. The method of claim 6, wherein the detector is a multifrequency impedance cytometer, and wherein the measured response signal is an impedance response.

8. The method of claim 1, where, for a given type of probe microparticle, the type of probe microparticle is configured to conjugate to the corresponding type of biological entity by binding to one or more surface receptors associated with the corresponding type of biological entity.

9. The method of claim 8, wherein:
the one or more surface receptors include one or more antigens; and
the type of probe microparticle is functionalized with one or more antibodies configured to bind the one or more antigens.

10. The method of claim 1, where, for a given type of probe microparticle, the metal oxide is an aluminum oxide, a hafnium oxide, or a titanium oxide.

11. The method of claim 1, where, for a given type of probe microparticle, the metal oxide coating has a thickness in a range of about 5 nm-30 nm.

12. The method of claim 1, wherein each of the one or more of the multiple frequencies corresponding to respective types of probe microparticles is in a range of about 1 MHz-30 MHz and another of the multiple frequencies is a reference frequency in a range of about 100 kHz-1 MHz.

13. The method of claim 1, wherein each of the one or more of the multiple frequencies is selected based on one or more properties of the respective type of probe microparticle.

14. The method of claim 13, wherein the one or more properties include at least one of: (i) metal oxide material and (ii) coating thickness.

15. The method of claim 1, wherein detecting the presence or absence of the one or more probe microparticles includes using a machine learning model.

16. The method of claim 15, wherein the machine learning model includes one or more of: (i) a neural network model, (ii) a support vector machine model, (iii) a naïve Bayes model, and (iv) an ensemble classifier model.

17. The method of claim 15, wherein the machine learning model is configured to analyze one or more features associated with the measured response signal, the one or more features including at least bipolar amplitude.

18. A system for detecting one or more probe microparticles, the system comprising:
a detector;
a processor; and
a memory with computer code instructions stored thereon, the processor and the memory, with the computer code instructions, being configured to cause the system to:
flow a biological entity through the detector in a conductive medium, the detector configured to:
apply an electric field to a biological entity, the electric field including multiple frequencies, one or more of the multiple frequencies corresponding to respective types of probe microparticles, each type of probe microparticle including a core and at least a partial metal oxide coating, and each type of probe microparticle configured to: (i) produce a response corresponding to a respective frequency and (ii) conjugate to a corresponding type of biological entity; and
responsive to applying the electric field, measure a response signal; and
detect, based on the measured response signal, presence or absence of one or more probe microparticles conjugated to the biological entity.

19. The system of claim 18, wherein the detector is a multifrequency impedance cytometer, and wherein the measured response signal is an impedance response.

20. A non-transitory computer program product for detecting one or more probe microparticles, the non-transitory computer program product comprising a computer-readable medium with computer code instructions stored thereon, the computer code instructions being configured, when executed by a processor, to cause an apparatus associated with the processor to:
apply an electric field to a biological entity, the electric field including multiple frequencies, one or more of the multiple frequencies corresponding to respective types of probe microparticles, each type of probe microparticle including a core and at least a partial metal oxide coating, and each type of probe microparticle configured to: (i) produce a response corresponding to a respective frequency and (ii) conjugate to a corresponding type of biological entity;
responsive to applying the electric field, measure a response signal; and
detect, based on the measured response signal, presence or absence of one or more probe microparticles conjugated to the biological entity.
